(19) United States
(12) Patent Application Publication
(10) Pub. No.: US 2026/0214696 A1
(43) Pub. Date: Jul. 23, 2026

(54) FREQUENCY DOMAIN ALLOCATION FOR A RANDOM ACCESS MESSAGE FOR SUB-BAND FULL DUPLEX COMMUNICATION

(71) Applicant: QUALCOMM Incorporated, San Diego, CA (US)

(72) Inventors: Mohammed JABI, San Diego, CA (US); Muhammad Sayed Khairy ABDELGHAFFAR, San Jose, CA (US)

(21) Appl. No.: 19/372,120

(22) Filed: Oct. 28, 2025

Related U.S. Application Data
(60) Provisional application No. 63/748,871, filed on Jan. 23, 2025.

(51) Int. Cl. H04W 74/02; H04W 74/00

(52) U.S. Cl. CPC H04W 74/02; H04W 74/006

(57) ABSTRACT

Methods, systems, and devices for wireless communications are described. A user equipment (UE) may receive information indicative of an initial uplink bandwidth part (BWP) and an active uplink BWP. The UE may transmit a random access preamble message and may receive a random access response message including an uplink grant. The UE may transmit, based on a first physical resource block (PRB), an uplink scheduled random access message. Transmission of the uplink scheduled random access message may be within a set of usable uplink PRBs that may be based on the active uplink BWP and an uplink sub-band of a sub-band full duplex (SBFD) configuration. Transmission of the uplink scheduled random access message within the set of usable uplink PRBs may be based on the first PRB being within the set of usable uplink PRBs or being offset from a reference PRB.

### CROSS REFERENCE

The present application for patent claims priority to U.S. Provisional Patent Application No. 63/748,871 by Jabi et al., entitled “FREQUENCY DOMAIN ALLOCATION FOR A RANDOM ACCESS MESSAGE FOR SUB-BAND FULL DUPLEX COMMUNICATION,” filed Jan. 23, 2025, assigned to the assignee hereof and incorporated by reference in its entirety.

### FIELD OF TECHNOLOGY

The following relates to wireless communications, including frequency domain allocation for a random access message for sub-band full duplex communication.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

Methods, systems, and devices, such as user equipment (UEs) and network entities, for wireless communications are described. A UE may receive information indicative of an initial uplink bandwidth part (BWP) and an active uplink BWP. The UE may transmit a random access preamble message and may receive a random access response message including an uplink grant. The UE may transmit, based on a first physical resource block (PRB), an uplink scheduled random access message. Transmission of the uplink scheduled random access message may be within a set of usable uplink PRBs that may be based on the active uplink BWP and an uplink sub-band of a sub-band full duplex (SBFD) configuration. Transmission of the uplink scheduled random access message within the set of usable uplink PRBs may be based on the first PRB being within the set of usable uplink PRBs or being offset from a reference PRB.

A network entity may transmit information indicative of an initial uplink BWP and an active uplink BWP. The network entity may receive a random access preamble message and may transmit a random access response message including an uplink grant. The network entity may receive, based on a first PRB, an uplink scheduled random access message. Reception of the uplink scheduled random access message may be within a set of usable uplink PRBs that may be based on the active uplink BWP and an uplink sub-band of a SBFD configuration. Reception of the uplink scheduled random access message within the set of usable uplink PRBs may be based on the first PRB being within the set of usable uplink PRBs or being offset from a reference PRB.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show examples of wireless communications systems that support frequency domain allocation for a random access message for sub-band full duplex (SBFD) communication in accordance with one or more aspects of the present disclosure.

FIG. 3 shows an example of a block diagram that supports frequency domain allocation for a random access message for SBFD communication in accordance with one or more aspects of the present disclosure.

FIGS. 4A and 4B show examples of bit diagrams that supports frequency domain allocation for a random access message for SBFD communication in accordance with one or more aspects of the present disclosure.

FIG. 5 shows an example of a block diagram that supports frequency domain allocation for a random access message for SBFD communication in accordance with one or more aspects of the present disclosure.

FIG. 6 shows an example of a process flow that supports frequency domain allocation for a random access message for SBFD communication in accordance with one or more aspects of the present disclosure.

FIGS. 7 and 8 show block diagrams of devices that support frequency domain allocation for a random access message for SBFD communication in accordance with one or more aspects of the present disclosure.

FIG. 9 shows a block diagram of a communications manager that supports frequency domain allocation for a random access message for SBFD communication in accordance with one or more aspects of the present disclosure.

FIG. 10 shows a diagram of a system including a device that supports frequency domain allocation for a random access message for SBFD communication in accordance with one or more aspects of the present disclosure.

FIGS. 11 and 12 show block diagrams of devices that support frequency domain allocation for a random access message for SBFD communication in accordance with one or more aspects of the present disclosure.

FIG. 13 shows a block diagram of a communications manager that supports frequency domain allocation for a random access message for SBFD communication in accordance with one or more aspects of the present disclosure.

FIG. 14 shows a diagram of a system including a device that supports frequency domain allocation for a random access message for SBFD communication in accordance with one or more aspects of the present disclosure.

FIGS. 15 and 16 show flowcharts illustrating methods that support frequency domain allocation for a random access message for SBFD communication in accordance with one or more aspects of the present disclosure.

### DETAILED DESCRIPTION

In some wireless communications systems, a network entity may operate according to full duplex (FD) communications. For example, a network entity may be able to transmit downlink messages and receive uplink messages at the same time. In some cases, the FD configuration may be a sub-band full duplex (SBFD) configuration, such that uplink and downlink communication may occur on different frequency resources. For example, uplink communication may occur on one or more sub-bands, while downlink communication may occur simultaneously on a different sub-band. In some cases, a user equipment (UE) communicating with the network entity may be able to operate via a half-duplex (HD) mode. That is, the UE may only be able to transmit or receive at separate times. In order to communicate with the network entity that communicates with SBFD, the UE that communicates with HD may transmit over uplink sub-bands of the SBFD configuration and, similarly, may receive over downlink sub-bands of the SBFD configuration, but not at the same time.

In some implementations, a UE may join the wireless communications system via a random access procedure, such as a four-step random access channel (RACH) procedure. The four-step random access procedure may include the UE transmitting a random access preamble message. The network entity may respond with a random access response, which may include an uplink grant indicating resources for the UE to use to transmit an uplink scheduled random access message (e.g., Msg3). For example, the uplink grant may provide a frequency domain resource allocation (FDRA) for transmission of the uplink scheduled random access message based on an initial uplink bandwidth part (BWP) (e.g., a BWP to be used prior to radio resource control (RRC) connection) or an active uplink BWP (e.g., a BWP used after RRC connection). In some cases, the FDRA may be within a range defined by a first physical resource block (PRB), which may be a first PRB of the initial uplink BWP or of the active uplink BWP, and a threshold quantity of PRBs, which may be the quantity of PRBs associated with the initial uplink BWP. The FDRA may indicate a resource indication value (RIV), which may be used to determine the resources for the transmission of the uplink scheduled random access message based on the first PRB and the threshold quantity of PRBs. For example, the RIV may be used to calculate or determine an offset, which may be applied to the first PRB to determine a starting PRB. The starting PRB may be the first PRB of the allocated resources for the transmission. The RIV may also be used to calculate or determine the length of the resource allocation (e.g., the quantity of PRBs for transmission). The length of the resource allocation may be limited by the threshold quantity of PRBs associated with the initial uplink BWP.

In some cases, if the network entity operates using an SBFD configuration, the UE may be limited to transmitting the uplink scheduled random access message within both the active uplink BWP and within the sub-band dedicated to uplink transmissions within the SBFD configuration. The PRBs within which the active uplink BWP and the uplink-configured sub-band may overlap may be known as the usable uplink PRBs. However, in some cases, the FDRA may not fall within the usable uplink PRBs. For example, the FDRA may be based on the first PRB of the active uplink BWP, which may be associated with a lower frequency than the usable uplink PRBs. The length of the initial uplink BWP may not extend far enough in frequency for there to be any possible PRBs of the FDRA within the usable uplink PRBs. That is, the UE may be unable to transmit the uplink scheduled random access message during any SBFD symbols, as the FDRA may not be allocated within the usable uplink PRBs (e.g., the PRBs by which the network entity may receive uplink transmissions). In some cases, the FDRA may overlap with the usable uplink PRBs, but the overlap may be minimal. This may result in less flexibility for scheduling the uplink scheduled random access message, or this may not be enough resources for the successful transmission of the uplink scheduled random access message.

The techniques described herein support methods for ensuring that at least a portion of the FDRA may be within the usable uplink PRBs. In some implementations, the first PRB from which the FDRA is defined may be adjusted to be a first PRB (e.g., PRB with a lowest frequency) in the usable uplink PRBs, or the first PRB may be offset from a reference PRB, such as a first PRB in the active uplink BWP or a first PRB in the initial uplink BWP. The offset may increase the likelihood that the starting PRB is within the usable uplink PRBs or that a majority of the FDRA may be within the usable uplink PRBs. In some cases, the FDRA may be included in a random access response message. The quantity of bits associated with the FDRA within the random access response message may be based on the size of the usable uplink PRBs or the active uplink BWP. In some cases, the starting RB and the length of the RBs for the FDRA may be adjusted using some scaling factors or offsets, which may maximize the overlap between the FDRA and the usable uplink PRBs. In some cases, the RACH procedure may fail. For example, the network entity may not receive the uplink scheduled random access message. The network entity may schedule retransmission of the uplink scheduled random access message via downlink control information (DCI), which may include a new uplink grant for the retransmission. The DCI may also schedule the retransmission such that the FDRA may be within the usable uplink PRBs, using the techniques as described with reference to the random access response message. Ensuring that at least a portion of an FDRA may be within the usable uplink PRBs may increase communication advantages provided by implementing an SBFD configuration, such as reduced latency, increased communication reliability, and improved utilization of communication resources.

Aspects of the disclosure are initially described in the context of wireless communications systems, block diagrams, bit diagrams, and process flows. Aspects of the disclosure are further illustrated by and described with reference to apparatus diagrams, system diagrams, and flowcharts that relate to frequency domain allocation for a random access message for sub-band full duplex communication.

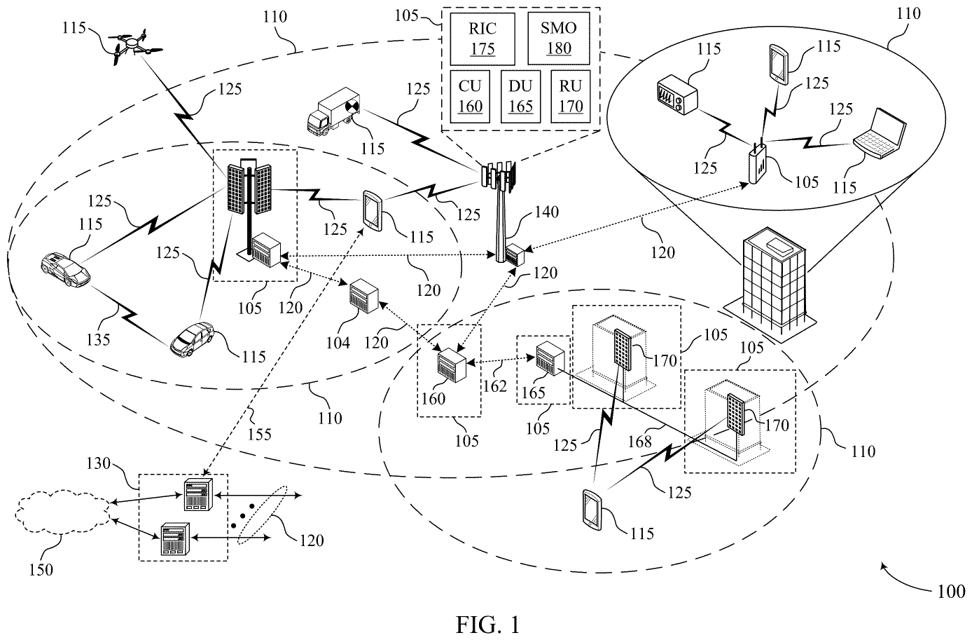

FIG. 1 shows an example of a wireless communications system 100 that supports frequency domain allocation for a random access message for sub-band full duplex communication in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (VIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support frequency domain allocation for a random access message for sub-band full duplex communication as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some wireless communications systems 100, a network entity 105 may operate according to SBFD communications, such that uplink and downlink communication may occur on different frequency resources. For example, uplink communication may occur on one sub-band, while downlink communication may occur simultaneously on a different sub-band. In some cases, a UE 115 communicating with the network entity 105 may communicate with HD. That is, the UE 115 may only be able to transmit or receive at separate times. In order to communicate with the network entity 105, the UE 115 may transmit over uplink sub-bands of the SBFD configuration and, similarly, may receive over downlink sub-bands of the SBFD configuration.

In some implementations, the UE 115 may join the wireless communications system via a random access procedure, such as a four-step RACH procedure. The four-step random access procedure may include the UE 115 transmitting a random access preamble message. The network entity 105 may respond with a random access response, which may include an uplink grant indicating resources for the UE 115 to use to transmit an uplink scheduled random access message (e.g., Msg3). For example, the uplink grant may provide a FDRA for transmission of the uplink scheduled random access message based on an initial uplink BWP (e.g., a BWP prior to RRC connection) or an active uplink BWP (e.g., a BWP used after RRC connection). In some cases, the FDRA may be within a range defined by a first PRB, which may be a first PRB of the initial uplink BWP or of the active uplink BWP, and a threshold quantity of PRBs, which may be the quantity of PRBs associated with the initial uplink BWP. The FDRA may indicate a RIV, which may be used to determine the resources for the transmission of the uplink scheduled random access message based on the first PRB and the threshold quantity of PRBs. For example, the RIV may be used to calculate or determine an offset, which may be applied to the first PRB to determine a starting PRB. The starting PRB may be the first PRB of the allocated resources for the transmission. The RIV may also be used to calculate or determine the length of the resource allocation (e.g., the quantity of PRBs for transmission). The length of the resource allocation may be limited by the threshold quantity of PRBs associated with the initial uplink BWP.

In some cases, if the network entity 105 operates using an SBFD configuration, the UE 115 may be limited to transmitting the uplink scheduled random access message within both the active uplink BWP and within the sub-band dedicated to uplink transmissions within the SBFD configuration. The PRBs within which the active uplink BWP and the uplink-configured sub-band may overlap may be known as the usable uplink PRBs. If the FDRA is not within the usable uplink PRBs, the uplink scheduled random access message may not be scheduled during SBFD symbols.

In some implementations, the network entity 105 and the UE 115 may operate such that at least a portion of the FDRA may be within the usable uplink PRBs. In some implementations, the first PRB from which the FDRA is defined may be adjusted to be a first PRB (e.g., PRB with a lowest frequency) in the usable uplink PRBs, or the first PRB may be offset from a reference PRB, such as a first PRB in the active uplink BWP or a first PRB in the initial uplink BWP. The offset may increase the likelihood that the starting PRB is within the usable uplink PRBs or that a majority of the FDRA may be within the usable uplink PRBs. In some cases, the FDRA may be included in a random access response message. The quantity of bits associated with the FDRA within the random access response message may be based on the size of the usable uplink PRBs or the active uplink BWP. In some cases, the starting RB and the length of the RBs for the FDRA may be adjusted using some scaling factors or offsets, which may maximize the overlap between the FDRA and the usable uplink PRBs. In some cases, the RACH procedure may fail. For example, the network entity 105 may not receive the uplink scheduled random access message. The network entity 105 may schedule retransmission of the uplink scheduled random access message via DCI, which may include a new uplink grant for the retransmission. The DCI may also schedule the retransmission such that the FDRA may be within the usable uplink PRBs, using the techniques as described with reference to the random access response message.

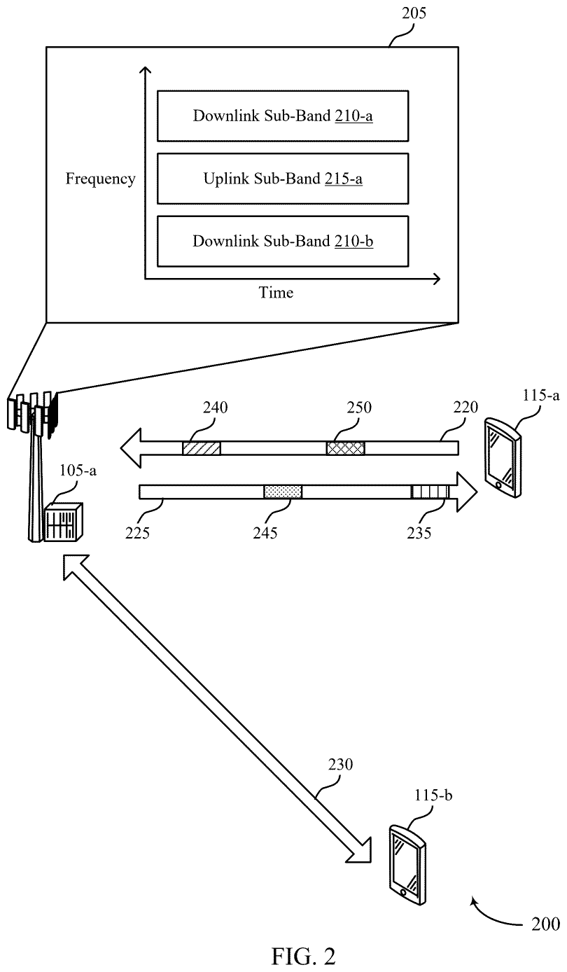

FIG. 2 shows an example of a wireless communications system 200 that supports frequency domain allocation for a random access message for SBFD communication in accordance with one or more aspects of the present disclosure. The wireless communications system 200 may implement, or be implemented by, aspects of the wireless communications system 100. For example, the wireless communications system 200 may include one or more network entities 105 and UEs 115, including at least the network entity 105-a and the UEs 115-a and 115 b, which may be examples of corresponding devices as described herein, including with reference to FIG. 1. The techniques described herein in the context of the wireless communications system 200 may support allocating frequency resources for an uplink scheduled random access message in accordance with an SBFD configuration.

In some wireless communications systems, one or more wireless devices, such as network entities 105 or UEs 115, may operate with FD communication. For example, the wireless device may transmit and receive messages at the same time. In some cases, the FD communication may be in-band full duplex (IBFD). A wireless device implementing IBFD communication may be able to transmit and receive on the same time and frequency resources. For example, the downlink and uplink resources may share the same time and frequency resources, either fully or partially (e.g., a partial or full overlap). In other cases, the FD communication may be SBFD (e.g., flexible duplex). A wireless device implementing SBFD communication may be able to transmit and receive at the same time, but on different frequency resources. That is, downlink resources may be separated from uplink resources in the frequency domain. In some examples, there may be some guard band between the downlink resources and uplink resources in the frequency domain. For example, an SBFD configuration 205 may include one or more downlink sub-bands 210, such as downlink sub-band 210-a and downlink sub-band 210-b, as well as one or more uplink sub-bands 215, such as uplink sub-band 215-a. The downlink sub-bands 210 and the uplink sub-bands 215 may overlap in time, but may be separated in frequency.

In some implementations, different FD configurations may support communication with different devices. For example, a network entity 105 that may implement an IBFD configuration may operate with UEs 115 that may support FD communication, or UEs 115 that may support SBFD communication. In some cases, the network entity 105 may be a multiple transmission-reception point (TRP) device, and may implement IBFD communication by using different TRPs for downlink or uplink communication. In some cases, a UE 115-a may not support or implement FD communication. For example, the UE 115-a may implement HD communication. That is, the UE 115-a may only be able to transmit or receive at one time. In some examples, the UE 115-b may also only support or implement HD communication. The network entity 105-a may implement an SBFD configuration 205, which may allow the network entity 105-a to communicate with the UE 115-a and the UE 115-b simultaneously. For example, the UE 115-a may communicate with the network entity 105-a via the uplink 220 using the uplink sub-band 215-a, while the UE 115-b may receive downlink transmissions simultaneously via the link 230 using a downlink sub-band 210. Additionally, or alternatively, the UE 115-a may communicate with the network entity 105-a via the downlink 225 using a downlink sub-band 210, while the UE 115-b may receive uplink transmissions simultaneously via the link 230 using the uplink sub-band 215-a. In this way, the UEs 115-a and 115-b may implement HD communication, while the network entity 105-a may use SBFD communication to simultaneously communicate with both UE 115-a and UE 115-b.

In some implementations, such as when the network entity 105-a may operate using the SBFD configuration 205, uplink and downlink scheduling may occur in one or more subsets of the PRBs that may be within the active downlink or uplink BWP for the UE 115-a. That is, for symbols during which the network entity 105-a may implement the SBFD configuration 205 (e.g., SBFD symbols), the UE 115-a, which may use HD communication within an active uplink BWP, may be limited or restricted to using a subset of the PRBs within the active uplink BWP that may overlap with the uplink sub-band 215-a. Additionally, or alternatively, the UE 115-a, which may use HD communication within an active downlink BWP, may be limited or restricted to receiving downlink transmissions in a subset of the PRBs within the active downlink BWP that may overlap with the downlink sub-bands 210. That is, the network entity 105-a may schedule transmission from the UE 115-a within the uplink sub-band 215-a, and may schedule transmission to the UE 115-a within the downlink sub-bands 210. For example, the UE 115-a may not transmit a message to the network entity 105-a using PRBs at a frequency that may be within the active uplink BWP for the UE 115-a, but may not be within the uplink sub-band 215-a. The subset of PRBs may be known as usable uplink PRBs, or usable downlink PRBs.

In some cases, usable uplink and downlink PRBs may be determined by the UE 115-a (e.g., implicitly determined) based on the cell-specific uplink or downlink SBFD configuration 205 (e.g., SBFD frequency configuration) and the active uplink or downlink BWP at the UE 115-a. In some examples, the network entity 105-a may not provide a UE-specific configuration on frequency locations of SBFD sub-bands (e.g., a configuration specific to the UE 115-a indicating where to transmit or receive). In some cases, the UE 115-a may determine the usable uplink and downlink PRBs using the cell-specific uplink or downlink SBFD configuration 205, which may not be based on whether the UE 115-a may be provided a UE-specific configuration. For an uplink BWP, the usable uplink PRBs within the SBFD symbols may be the PRBs within the intersection between the uplink sub-band, such as the uplink sub-band 215-a, and the active uplink BWP (e.g., uplink BWP). For a downlink BWP, the usable downlink PRBs within the SBFD symbols may be the PRBs within the intersection between the downlink sub-bands 210 and the active downlink BWP (e.g., downlink BWP).

In some implementations, a UE 115-a may join a cell served by a network entity 105-a via a random access procedure (e.g., initial access procedure). In some cases, the network entity 105-a may provide some information 235 indicative of an initial uplink BWP, an active uplink BWP, or both. The initial uplink BWP may be used for initial access prior to an establishment of an RRC connection between the network entity 105-a and the UE 115-a. The information 235 may indicate the initial uplink BWP. For example, the information 235 may include a system information block (SIB), which may indicate or include an initial uplink BWP configuration. The active uplink BWP may refer to a BWP that may be activated after the RRC connection may be established. For example, the active uplink BWP may be a configured BWP used for configuration or activation of a cell, such as during a connection establishment or re-establishment procedure. The information 235 may indicate the active uplink BWP. For example, the information 235 may include control signaling or a configuration message indicating one or more uplink BWP configurations. The UE 115-a and the network entity 105-a may activate and operate according to an uplink BWP configuration of the one or more uplink BWP configurations, which may be the active uplink BWP. In some cases, the initial uplink BWP and the active uplink BWP may be configured via a same message, such as a same SIB. In other cases, the initial uplink BWP and the active uplink BWP may be configured or reconfigured via separate messages.

In some cases, the random access procedure may be a four-step random access procedure. That is, the UE 115-a may transmit a random access preamble message 240 (e.g., Msg1) to the network entity 105-a. The network entity 105-a may respond with a random access response message 245 (e.g., Msg2), which may include an uplink grant, including an FDRA. The UE 115-a may use the uplink grant to transmit an uplink scheduled random access message 250 (e.g., Msg3), which may be a physical uplink shared channel (PUSCH) message. In some implementations, the random access response message 245 may indicate the FDRA based on a first resource block (RB) (e.g., PRB) and a threshold quantity of RBs. The first RB may be an RB that acts as a first RB from which the RBs in the FDRA may be counted. For example, the first RB may be a reference or starting point from which the FDRA may be defined. In some cases, the first RB may be an RB of a lowest frequency. The threshold quantity of RBs may be some limit on the FDRA, such that the FDRA does not exceed the threshold quantity of RBs. That is, the FDRA may, at most, extend from the first RB through the threshold quantity of RBs.

In some cases, the first RB and the threshold quantity of RBs may be pre-configured or defined based on some rule, such that the UE 115-a and the network entity 105-a may use the same FDRA and the UE 115-a may determine which frequency domain resources may be included in the uplink grant. For example, the UE 115-a may determine the allocated resources indicated in the FDRA of the random access response message 245 based on some reference BWPs. For example, in some cases, the active uplink BWP and the initial uplink BWP may have a same subcarrier spacing (SCS) and same cyclic prefix (CP) length. The active uplink BWP may include all the RBs of the initial uplink BWP or the active uplink BWP may be the initial uplink BWP, and the initial uplink BWP may be used as a reference BWP. For example, the first PRB may be the first PRB (e.g., the PRB of the lowest frequency) of the initial uplink BWP and the threshold quantity of PRBs may be the same as a quantity of PRBs in the initial uplink BWP. In some examples, the UE 115-a may determine the FDRA for the PUSCH transmission within an active uplink BWP at the UE 115-a based on a parameter not being configured, provided, or indicated (e.g., useInterlacePUCCH-PUSCH is not provided by BWP-UplinkCommon and BWP-UplinkDedicated).

In other cases, the active uplink BWP and the initial uplink BWP may not have a same subcarrier spacing (SCS) or a same cyclic prefix (CP) length, and the active uplink BWP may not include all the RBs of the initial uplink BWP or the active uplink BWP may not be the initial uplink BWP. In these cases, the active uplink BWP and initial uplink BWP may both be used as reference BWPs. For example, the first PRB may be the first PRB (e.g., PRB of a lowest frequency) of the active uplink BWP, while the threshold quantity of RBs may be the quantity of PRBs in the initial uplink BWP. Defining a first PRB and a threshold quantity of PRBs may define the range of possible resources allocated in the FDRA.

In some implementations, the uplink grant in the random access response message 245 may be a set quantity of bits (e.g., 14 bits). For example, the FDRA may be a specific uplink resource allocation type (e.g., type 1). As noted above, an initial uplink BWP may include some quantity of PRBs

$$( e . g . , {N}_{B W P}^{s i z e} PRBs ) .$$

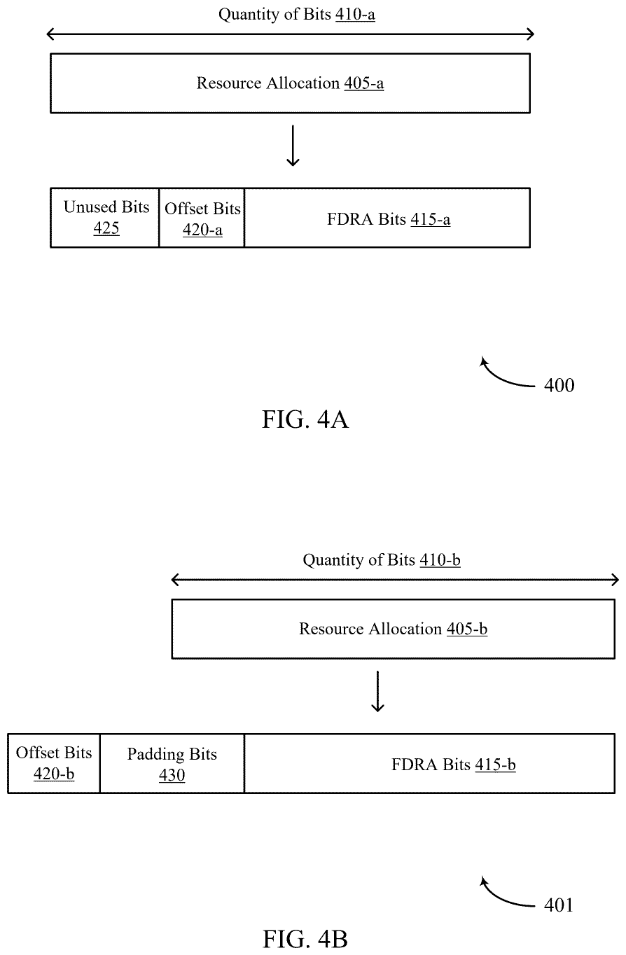

In order to ensure the threshold quantity of PRBs may be indicated in the set quantity of bits, the FDRA field in the random access response message may be expanded or truncated, as described further with reference to FIGS. 4A and 4B. For example, the set quantity of bits may support a set threshold quantity of PRBs (e.g., 180, 90 for shared spectrum channel access). If the size of the initial uplink BWP (e.g., the threshold quantity of PRBs) is less than (or equal to) the set threshold quantity of PRBs that the set quantity of bits may support

$$( e . g . , {N}_{B W P}^{s i z e} \leq 180 , 90 ) ,$$

the FDRA field in the random access response message 245 may be truncated. For example, the FDRA field may be truncated to

$${log}_{2} ( {N}_{B W P}^{s i z e} * \frac{{N}_{B W P}^{s i z e} + 1}{2} ) - {N}_{h o p}^{U L}$$

least significant bits. The random access response message may include some unused bits, a quantity of uplink frequency hopping bits

$$( {N}_{h o p}^{U L} ) ,$$

as described further with reference to Table 1, and the truncated FDRA field. If the size of the initial uplink BWP is greater than the set threshold quantity of PRBs

$$( e . g . , {N}_{B W P}^{s i z e} > 180 , 90 ) ,$$

then the FDRA field may be expanded. For example,

$${log}_{2} ( {N}_{B W P}^{s i z e} * \frac{{N}_{B W P}^{s i z e} + 1}{2} ) - 14$$

most significant bits may be inserted in the FDRA field (or

$${log}_{2} ( {N}_{B W P}^{s i z e} * \frac{{N}_{B W P}^{s i z e} + 1}{2} ) - 12$$

most significant bits, for shared spectrum channel access). That is, the FDRA field may be expanded to

$$14 - {N}_{h o p}^{U L}$$

most significant bits. Some padding bits (e.g., bits set to 0) may be introduced between the FDRA and a quantity of uplink frequency hopping bits

$$( {N}_{h o p}^{U L} ) ,$$

as described further with reference to Table 1. In some cases, inclusion of the frequency hopping bits may further limit the length of the FDRA field.

In some implementations, the uplink scheduled random access message 250 may not be successfully received or decoded by the network entity 105-a, or the uplink scheduled random access message 250 may be retransmitted. Retransmissions of the uplink scheduled random access message 250 may be scheduled by a DCI (e.g., DCI format 0_0 with cyclic redundancy check (CRC) scrambled by a temporary cell radio network identifier (TC-RNTI)). The FDRA for the retransmitted random access response message may be a set quantity of bits

$$( e . g . , {log}_{2} ( {N}_{B W P}^{s i z e} * \frac{{N}_{B W P}^{s i z e} + 1}{2} )$$

based on the size of the initial BWP

$$( {N}_{B W P}^{s i z e} ) ( e . g . , {N}_{R B}^{UL , BWP} ) .$$

The quantity of bits in the FDRA field in the DCI may be changed or may not be the set quantity of bits (e.g., expansion or truncation of the FDRA field), and the quantity of bits of the DCI may be determined similarly to the FDRA field (e.g., the expanded or truncated FDRA field) in the random access response message. Additionally, or alternatively, the DCI may include a quantity of uplink frequency hopping bits

$$( {N}_{h o p}^{U L} ) ,$$

as described further with reference to Table 1. Inclusion of the frequency hopping bits may further limit the length of the FDRA field.

In some cases, as described herein, there may be some quantity of uplink frequency hopping bits

$$( {N}_{h o p}^{U L} ) ,$$

within the uplink grant in the random access response message 245 or the DCI for scheduling the uplink scheduled random access message 250 retransmissions. The quantity of uplink frequency hopping bits may be dependent on whether frequency hopping may be configured, where the frequency hopping bits may indicate a frequency offset for the hopping, as in Table 1. Table 1 may show a frequency offset for a second hop of a PUSCH transmission with the frequency hopping scheduled by an uplink grant in a random access response message or an uplink grant for retransmission (e.g., DCI), such as the uplink scheduled random access message 250.

TABLE 1
Example of Frequency Offset for Second Hop of PUSCH Transmission
with Frequency Hopping

| Number of PRBs in | $Value of {N}_{hop}^{U L} Hopping$ | Frequency Offset for |
|---|---|---|
| Initial Uplink BWP | Bits | Second Hop |
| ${N}_{B W P}^{s i z e} < 50$ | 0 | $\frac{{N}_{B W P}^{s i z e}}{2}$ |
| | 1 | $\frac{{N}_{B W P}^{s i z e}}{4}$ |
| ${N}_{B W P}^{s i z e} \geq 50$ | 00 | $\frac{{N}_{B W P}^{s i z e}}{2}$ |
| | 01 | $\frac{{N}_{B W P}^{s i z e}}{4}$ |
| | 10 | $- \frac{{N}_{B W P}^{s i z e}}{4}$ |
| | 11 | Reserved |

In some implementations, the FDRA field in the RAR or the DCI may include or indicate a RIV. The RIV may indicate which resources within the possible resources that the UE 115-a may use for the Msg3 transmission. That is, based on the first PRB, the threshold quantity of PRBs, and the RIV, the UE 115-a may determine which resources to use for transmission of the uplink scheduled random access message 250 (and the network entity 105-a may determine which resources to schedule and monitor). The RIV may correspond to a starting virtual RB (RBₛₜₐᵣₜ) for the resource allocation and a length, in terms of contiguously allocated RBs, for the resource allocation (L_{RBs}). That is, based on the threshold quantity of RBs

$$( e . g . , the size of the initial uplink BWP , {N}_{BWP}^{size} )$$

a virtual starting RB of the allocated resources and the quantity of allocated resources may be determined using the RIV, as in Equation 1. Thus, the virtual starting RB may, based on the RIV, be offset from or counted from the first RB (e.g., the first RB of the active uplink BWP or the initial uplink BWP).

$$if ( {L}_{RBs} - 1 ) \leq \frac{{N}_{B W P}^{s i z e}}{2} , then RIV = {N}_{B W P}^{s i z e} ( {L}_{RBs} - 1 ) + {RB}_{start} \qquad ( 1 )$$

$$else : RIV = {N}_{B W P}^{s i z e} ( {N}_{B W P}^{s i z e} - {L}_{R B s} + 1 ) + ( {N}_{B W P}^{s i z e} - 1 - R {B}_{start} )$$

where L_{RBs}≥1 and L_{RBs} may not exceed

$${N}_{B W P}^{s i z e} - R {B}_{start} .$$

In some cases, if the network entity 105-a operates using the SBFD configuration 205, the UE 115-a may be limited to transmitting the uplink scheduled random access message within both the active uplink BWP and within the uplink sub-band 215-a. The PRBs (e.g., RBs) within which the active uplink BWP and the uplink-configured sub-band may overlap may be known as the usable uplink PRBs. If the allocated resources of the FDRA are not within the usable uplink PRBs, the uplink scheduled random access message may not be scheduled during SBFD symbols.

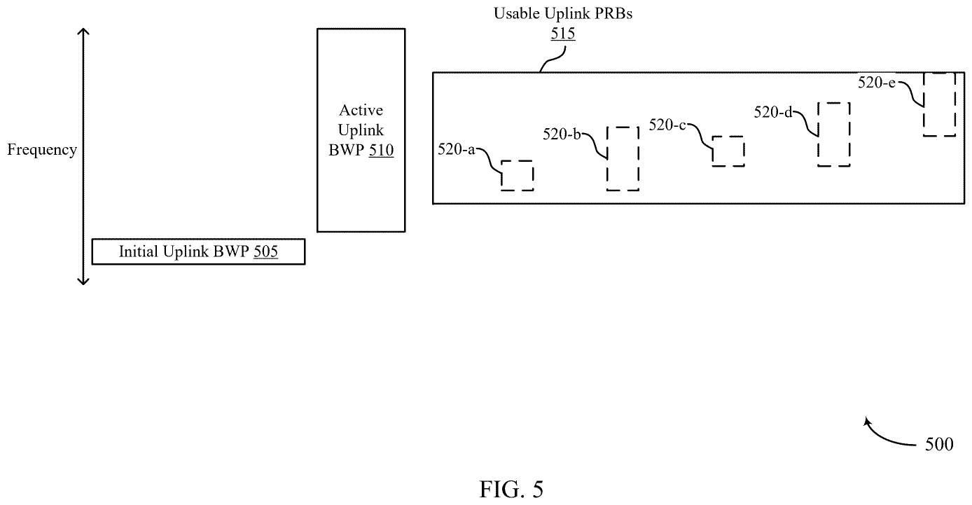

In some implementations, the network entity 105-a and the UE 115-a may operate such that at least a portion of the allocated resources indicated in the random access response message 245 (or the uplink grant for retransmission indicated in the DCI) may be within the usable uplink PRBs. In some implementations, the first PRB from which the FDRA is defined may be adjusted to be a first PRB (e.g., PRB with a lowest frequency) in the usable uplink PRBs, or the first PRB may be offset from a reference PRB, such as a first PRB in the active uplink BWP or a first PRB in the initial uplink BWP. The offset may increase the likelihood that the starting PRB may be within the usable uplink PRBs or that a majority of the FDRA may be within the usable uplink PRBs. In some cases, the FDRA may be included in the random access response message 245. The quantity of bits associated with the FDRA within the random access response message 245 may be based on the size of the usable uplink PRBs or the active uplink BWP, as described further with reference to FIGS. 4A and 4B. In some cases, the starting RB and the length of the RBs for the FDRA may be adjusted using some scaling factors or offsets, which may maximize the overlap between the FDRA and the usable uplink PRBs, as described further with reference to FIG. 5. In some cases, the RACH procedure may fail. For example, the network entity 105-a may not receive the uplink scheduled random access message 250. The network entity 105-a may schedule retransmission of the uplink scheduled random access message 250 via DCI, which may include a new uplink grant for the retransmission. The DCI may also schedule the retransmission such that the FDRA may be within the usable uplink PRBs, using the techniques as described with reference to the random access response message 245.

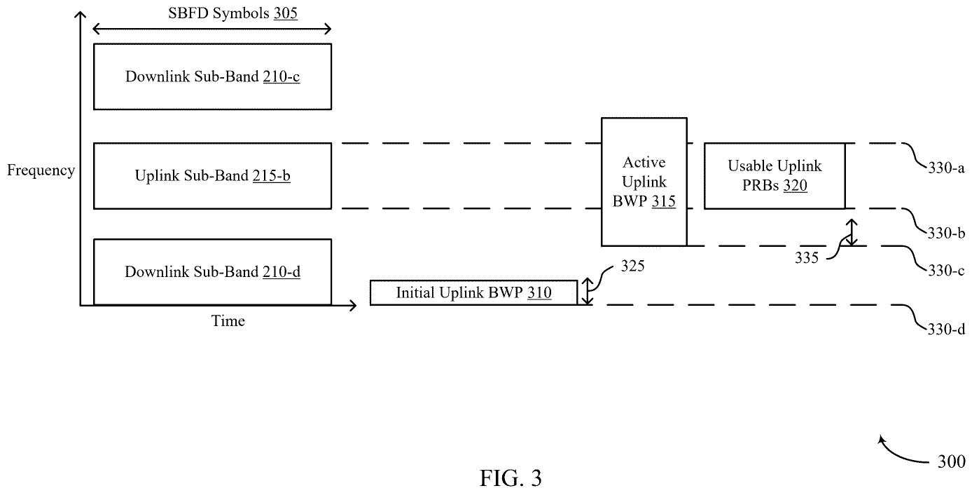

FIG. 3 shows an example of a block diagram 300 that supports frequency domain allocation for a random access message for SBFD communication in accordance with one or more aspects of the present disclosure. The wireless block diagram 300 may implement, or be implemented by, aspects of the wireless communications systems 100 and 200. For example, the block diagram 300 may include one or more downlink sub-bands 210 and uplink sub-bands 215, including at least the downlink sub-bands 210-c and 210-d and the uplink sub-band 215-b, which may be examples of corresponding sub-bands described herein, including with reference to FIG. 2. The block diagram 300 may be one of many examples that may support frequency domain allocation for a random access message for SBFD communication in accordance with one or more aspects of the present disclosure. For example, one or more aspects of the present disclosure, including those described with reference to FIG. 3, may be implemented for wireless communications systems or block diagrams with one or more downlink sub-bands 210 and one or more uplink sub-bands 215 that may differ from the downlink sub-bands 210 and uplink sub-bands 215 illustrated in the block diagram 300. The techniques described herein in the context of the block diagram 300 may support allocating frequency resources for an uplink scheduled random access message with a set of usable uplink PRBs 320, in accordance with an SBFD configuration.

In some wireless communications systems, as described herein, a network entity may implement an SBFD configuration while communicating with a UE that may use a HD configuration. The SBFD configuration may include one or more sub-bands (e.g., downlink sub-bands 210, uplink sub-bands 215), within which only uplink or downlink communication may occur. For example, over SBFD symbols 305, the SBFD configuration may include downlink sub-bands 210 and an uplink sub-band 215-c. The network entity may receive, during SBFD symbols, transmissions from the UE over the uplink sub-band 215-b and not over downlink sub-bands 210.

In some implementations, a UE may establish a radio resource control (RRC) connection with a network entity via a random access procedure. The UE may communicate according to some initial uplink BWP 310 prior to establishing the RRC connection and may communicate according to an active uplink BWP 315 after or while a RRC connection may be established. During the random access procedure, the UE may transmit a random access preamble message (Msg1) and may receive a random access response message (Msg2) in response. The random access response message may include an uplink grant for transmitting an uplink scheduled random access message (Msg3) that may be a PUSCH message. In order for the network entity to receive the uplink scheduled random access message during the SBFD symbols 305, the network entity may schedule, and the UE may transmit, the uplink scheduled random access message within the uplink sub-band 215-b. Additionally, or alternatively, the UE may transmit the uplink scheduled random access message within the active uplink BWP 315. In order for the UE to transmit, and the network entity to receive, the uplink scheduled random access message, the UE may transmit the uplink scheduled random access message over some usable uplink PRBs 320. The usable uplink PRBs may be the intersection or overlap between the uplink sub-band 215-b and the active uplink BWP 315. For example, reference lines 330-a and 330-b indicate the intersection between the uplink sub-band 215-b and the active uplink BWP 315.

In some implementations, as described further with reference to FIG. 2, the uplink grant for the uplink scheduled random access message may be or include some FDRA that may be based on a first PRB and a threshold quantity of PRBs. In some cases, the first PRB and the threshold quantity of PRBs may be based on a reference BWP, such as the initial uplink BWP 310, the active uplink BWP 315, or both. In some examples, the first PRB may be based on the active uplink BWP 315, such as the first PRB of the active uplink BWP 315. The first PRB of the active uplink BWP 315 may be the lowest frequency PRB of the active uplink BWP 315. For example, the reference line 330-c may indicate the first PRB of the active uplink BWP 315. In other examples, such as when the initial uplink BWP 310 and the active uplink BWP 315 may overlap (among other examples, as described further with reference to FIG. 2), the first PRB may be based on the first PRB in the initial uplink BWP.

The threshold quantity of PRBs may be based on the initial uplink BWP 310. For example, the threshold quantity of PRBs may be the same as a quantity of PRBs 325 in the initial uplink BWP. The FDRA for the uplink scheduled random access message may include any PRBs from the first PRB through the threshold quantity of PRBs. For example, the possible PRBs for the FDRA may include any PRBs from the reference line 330-c, through a frequency or quantity of PRBs the same as the quantity of PRBs 325.

In some cases, the potential resources for the FDRA may not include any PRBs within the usable uplink PRBs 320. That is, the potential resources stretching from the first PRB (e.g., reference line 330-c) through the threshold quantity of PRBs 335 (e.g., equivalent to the quantity of PRBs 325) may not extend or overlap with the usable uplink PRBs. In this case, the uplink scheduled random access message may not be scheduled during SBFD symbols 305, as the UE 115-a may, during the SBFD symbols 305, only use frequency resources within the uplink usable PRBs 320 for uplink transmissions. That is, the network entity may be unable to receive the uplink scheduled random access message during the SBFD symbols 305. In other cases, the potential resources for the FDRA may partially overlap with the usable uplink PRBs 320. However, any resources not within the usable uplink PRBs 320, such as any resources below the reference line 330-b, may be wasted. This may limit the scheduling flexibility for the UE within the SBFD symbols 305. In some examples, the overlap may not include enough resources for the transmission of the uplink scheduled random access message and the uplink scheduled random access message may not be scheduled during SBFD symbols 305.

In some implementations, the FDRA grant for the uplink scheduled random access message may be implemented such that the FDRA may be at least partially within the usable uplink PRBs 320. For example, the first PRB may be defined to be within the usable uplink PRBs 320, such that the RB numbering for the PRB may begin within the usable uplink PRBs 320. In some cases, the first PRB may be defined as the first PRB of the usable uplink PRBs 320, such as indicated by the reference line 330-b. In other cases, the first PRB may be based on a reference PRB and an offset. For example, the reference PRB may be the first PRB in the active uplink BWP 315 (e.g., reference line 330-c, and the offset may be some RB offset, such as a quantity of PRBs between the reference line 330-d and the reference line 330-b. That is, the first PRB may be the first PRB of the usable uplink PRBs 320 based on the offset and the reference PRB. Additionally, or alternatively, the reference PRB may be the first PRB in the initial uplink BWP 310 (e.g., reference line 330-d), and the offset may be some RB offset, such as a quantity of PRBs between the reference line 330-c and the reference line 330-b. That is, the first PRB may be the first PRB of the usable uplink PRBs 320 based on the offset and the reference PRB. In some cases, the offset may not indicate the first PRB to be the first PRB of the usable uplink PRBs 320, but may place the first PRB within the usable uplink PRBs 320 based on the reference. In other cases, the first PRB may not be within the usable uplink PRBs 320, but may be offset from the reference PRB to improve the likelihood that a large portion of the available resources for the FDRA may be within the usable uplink PRBs 320.

FIGS. 4A and 4B show examples of bit diagrams 400 and 401, respectively, that support frequency domain allocation for a random access message for SBFD communication in accordance with one or more aspects of the present disclosure. The bit diagrams 400 and 401 may implement, or be implemented by, aspects of the wireless communications systems 100 and 200, as well as the block diagram 300. The techniques described herein in the context of the bit diagrams 400 and 401 may support determining a quantity of bits for an FDRA field, as well as a truncation or expansion of the FDRA bits, based on an active uplink BWP or a set of usable uplink PRBs, in accordance with an SBFD configuration.

In some wireless communications systems, a resource allocation 405 (e.g., a frequency resource allocation, FDRA), such as a random access response message or a DCI, may be some quantity of bits 410

$$( e . g . , 14 bits for a RAR and {log}_{2} ( {N}_{B W P}^{s i z e} * \frac{{N}_{B W P}^{s i z e} + 1}{2} )$$

bits for a DCI, where

$${N}_{B W P}^{s i z e}$$

is the size (e.g., quantity of RBs) of an initial downlink BWP). The resource allocation 405 may use some quantity of FDRA bits 415 to indicate allocated resources. The quantity of FDRA bits 415 may be based on a quantity of PRBs or a size of a BWP. For example, in some cases, the quantity of FDRA bits 415 may be based on the size of the initial uplink BWP. In other cases, the quantity of FDRA bits may be based on a size of an active uplink BWP or a size of a set of usable uplink PRBs (e.g., active usable uplink PRBs). In some cases, the quantity of FDRA bits 415 may be less than the quantity of bits 410, or may be less than the quantity of bits 410 without the quantity of offset bits 420, and the resource allocation message may be truncated, as in FIG. 4A. In other cases, the quantity of FDRA bits 415 may exceed the quantity of bits 410, or may exceed the quantity of bits 410 without the quantity of offset bits 420, and the resource allocation 405 may be expanded, as in FIG. 4B. The quantity of offset bits 420-a (Nₕₒₚ^{UL}) may be based on whether frequency hopping may be implemented or activated by the UE, as described further with reference to FIG. 2 and Table 1. In some implementations, as described in FIG. 4A and FIG. 4B, the resource allocation 405 may be expanded or truncated based on the size of the active uplink BWP or the size of the set of usable uplink PRBs.

With respect to bit diagram 400, the quantity of bits 410-a for the resource allocation 405-a may be truncated based on the size of an active uplink BWP or based on the size (e.g., quantity) of usable uplink PRBs. The size of the active uplink BWP or the size of the usable uplink PRBs may be denoted by

$${N}_{R B}^{UL , BWP}$$

(e.g.,

$${N}_{R B}^{UL , BWP}$$

may refer to the size of the active uplink BWP or the size of the usable uplink PRBs, in accordance with whether the active uplink BWP is used as the truncation reference or the usable uplink PRBs are used as the truncation reference).

In some implementations, the resource allocation 405-a (e.g., frequency resource allocation) may be part of a random access response message, and may be a quantity of bits 410-a (e.g., 14 bits).

$${N}_{R B}^{UL , BWP}$$

may be below or equal to a threshold associated with the set quantity of bits

$$( e . g . , {N}_{R B}^{UL , BWP} \leq 180 ) .$$

A wireless device, such as a UE or a network entity, may truncate the FDRA field of the resource allocation 405-a, which may be some quantity of bits 410-a (e.g., fixed to 14 bits), such that the FDRA bits 415-a may be

$${log}_{2} ( {N}_{R B}^{UL , BWP} * \frac{{N}_{R B}^{UL , BWP} + 1}{2} ) - {N}_{h o p}^{U L}$$

least significant bits. The resource allocation 405-a may include the FDRA bits 415-a, which may be truncated based on

$${N}_{R B}^{UL , BWP} ,$$

and may also include offset bits 420-a

$$( {N}_{h o p}^{U L} ) .$$

The excess bits of the quantity of bits 410-a may be the unused bits 425.

In some implementations, the resource allocation 405-a may be part of a DCI message, and may be a quantity of bits 410-a that may be based on the size of the initial BWP

$$( {N}_{R B}^{UL , BWP , initial} ) ( e . g . , {N}_{B W P}^{s i z e} ) .$$

For example, the quantity of bits 410-a may be

$${log}_{2} ( {N}_{R B}^{UL , BWP , initial} * \frac{{N}_{R B}^{UL , BWP , initial} + 1}{2} ) .$$

In some cases,

$${N}_{R B}^{U L , B W P}$$

may be below or equal to

$${N}_{R B}^{UL , BWP , initial} ,$$

and the FDRA field of the resource allocation 405-a may be obtained through a truncation of the quantity of bits 410-a associated with resource allocation 405-a. For example, a wireless device, such as a UE or a network entity, may truncate the FDRA field of the resource allocation 405-a such the FDRA bits 415-a may be

$${log}_{2} ( {N}_{R B}^{UL , BWP} * \frac{{N}_{R B}^{UL , BWP} + 1}{2} ) - {N}_{h o p}^{U L}$$

least significant bits of the resource allocation 405-a field. That is, the resource allocation 405-a may include the FDRA bits 415-a, which may be truncated based on

$${N}_{RB}^{UL , BWP} ,$$

and may include offset bits 420-a

$$( {N}_{hop}^{UL} ) .$$

The excess bits of the quantity of bits 410-a may be the unused bits 425.

In some implementations, the FDRA bits 415-a may be increased to fill some or all of the unused bits 425. That is, for

$${N}_{RB}^{UL , BWP} R Bs , {log}_{2} ( {N}_{RB}^{UL , BWP} * \frac{{N}_{RB}^{UL , BWP} + 1}{2} )$$

bits may be used for the resource allocation 405-a to cover all possible values of virtual starting RBs (e.g., based on possible allocation offsets) and lengths. However, when

$${N}_{RB}^{UL , BWP}$$

is less than or equal to the RBs associated with the set quantity of bits of the resource allocation 405-a (e.g., 180 for a random access response message

$${N}_{RB}^{UL , BWP , initial}$$

for a DCI), only a subset of the available bits may be used

$$( e . g . , {log}_{2} ( {N}_{RB}^{UL , BWP} * \frac{{N}_{RB}^{UL , BWP} + 1}{2} ) - {N}_{hop}^{UL} ) .$$

That is, unused bits 425 may be wasted. The quantity of unused bits 425 may be

$$14 - {log}_{2} ( {N}_{RB}^{UL , BWP} * \frac{{N}_{RB}^{UL , BWP} + 1}{2} )$$

for a random access response message and

$${log}_{2} ( {N}_{RB}^{UL , BWP , initial} * \frac{{N}_{RB}^{UL , BWP , initial} + 1}{2} ) - {log}_{2} ( {N}_{RB}^{UL , BWP} * \frac{{N}_{RB}^{UL , BWP} + 1}{2} )$$

bits for a DCI.

In some cases, it may be beneficial to expand the FDRA bits 415-a in order to cover all possible values of virtual starting RBs (e.g., based on possible allocation offsets) and lengths by using one or more of the unused bits 425. For example, for a random access response message, if

$${N}_{UL , hop} = 0 and {N}_{RB}^{UL , BWP} \leq 180 , {N}_{UL , hop} = 1 and {N}_{RB}^{UL , BWP} \leq 127 , or {N}_{UL , hop} = 2 and {N}_{RB}^{UL , BWP} \leq 90 ,$$

then the FDRA bits 415-a may be

$${log}_{2} ( {N}_{RB}^{UL , BWP} * \frac{{N}_{RB}^{UL , BWP} + 1}{2} )$$

least significant bits of the resource allocation 405-a. Otherwise, the FDRA bits 415-a may be

$$14 - {N}_{hop}^{UL}$$

least significant bits. For an uplink grant for retransmission (e.g., DCI), if

$${N}_{UL , hop} = 0 and {N}_{RB}^{UL , BWP} \leq {N}_{RB}^{UL , BWP , initial} , {N}_{UL , hop} = 1 and {log}_{2} ( {N}_{RB}^{UL , BWP} \cdot \frac{{N}_{RB}^{UL , BWP} + 1}{2} ) \leq {log}_{2} ( {N}_{RB}^{UL , BWP , initial} \cdot \frac{{N}_{RB}^{UL , BWP , initial} + 1}{2} ) - 1 ) , or {N}_{UL , hop} = 2 and {log}_{2} ( {N}_{RB}^{UL , BWP} \cdot \frac{{N}_{RB}^{UL , BWP} + 1}{2} ) \leq {log}_{2} ( {N}_{RB}^{UL , BWP , initial} \cdot \frac{{N}_{RB}^{UL , BWP , initial} + 1}{2} ) - 2 ,$$

then the FDRA bits 415-a may be

$${log}_{2} ( {N}_{RB}^{UL , BWP} * \frac{{N}_{RB}^{UL , BWP} + 1}{2} )$$

least significant bits. Otherwise, the FDRA bits 415-a may be

$${log}_{2} ( {N}_{RB}^{UL , BWP , initial} * \frac{{N}_{RB}^{UL , BWP , initial} + 1}{2} ) - {N}_{UL , hop}$$

least significant bits.

Thus, in some examples, the truncated FDRA bits 415-a may be extended to fill the unused bits 425 (or to fill a subset of the unused bits 425), and the FDRA bits 415-a may include enough bits to cover all possible values of virtual starting RBs (e.g., based on possible allocation offsets) and lengths. For example, for N_{UL,hop}=2 and

$${N}_{RB}^{UL , BWP} = 90 ,$$

the FDRA bits 415-a may be truncated to 10 bits (e.g., according to specified requirements or standards). After increasing the FDRA bits 415-a to cover the possible values of the virtual starting RBs and lengths, the FDRA bits 415-a may instead include 12 bits, and the resource allocation 405-a may include two offset bits 420-a and the twelve FDRA bits 415-a (e.g., 14 total bits). In another example, N_{UL,hop}=1 (e.g., one offset bit 420-a). The FDRA bits 415-a may be increased to 12 bits in order to cover the possible values of the virtual starting RBs and lengths, and the resource allocation 405-a may include one unused bit 425, the one offset bit 420-a, and the twelve FDRA bits 415-a

With respect to bit diagram 401, the quantity of bits 410-b for a resource allocation 405-b may be expanded based on the size of an active uplink BWP or based on the size (e.g., quantity) of usable uplink PRBs. The size of the active uplink BWP or the size of the usable uplink PRBs may be denoted by

$${N}_{RB}^{UL , BWP} ( e . g . , {N}_{RB}^{UL , BWP}$$

may refer to the size of the active uplink BWP or the size of the usable uplink PRBs, in accordance with which is used as the expansion reference).

In some implementations, the resource allocation 405-b (e.g., frequency resource allocation) may be part of a random access response message, and may be a quantity of bits 410-b (e.g., 14 bits).

$${N}_{RB}^{UL , BWP}$$

may exceed a threshold associated with the quantity of bits 410-b

$$( e . g . , {N}_{RB}^{UL , BWP} > 180 ) .$$

A wireless device, such as a UE or a network entity, may expand the resource allocation 405-b, such that the resource allocation 405-b may be

$${log}_{2} ( {N}_{RB}^{UL , BWP} * \frac{{N}_{RB}^{UL , BWP} + 1}{2} ) bits$$

and the FDRA bits 415-b may be 14—

$${N}_{hop}^{UL}$$

least significant bits. After expanding the resource allocation 405-b, the FDRA field may include enough FDRA bits 415-b to cover all possible values of the virtual starting RB and lengths. That is, the resource allocation 405-b may be expanded based on

$${N}_{RB}^{UL , BWP}$$

in order to accommodate the FDRA bits 415-b. The resource allocation 405-b may include offset bits 420-b based on the

$${N}_{hop}^{UL} .$$

Padding bits 430 (e.g., bits with values set to 0) may be introduced between the offset bits 420-b and the FDRA bits 415-b after the expansion, such that the expanded resource allocation 405-b may be

$${log}_{2} ( {N}_{RB}^{UL , BWP} * \frac{{N}_{RB}^{UL , BWP} + 1}{2} )$$

bits. That is, the resource allocation 405-b after the expansion may include

$${log}_{2} ( {N}_{RB}^{UL , BWP} * \frac{{N}_{RB}^{UL , BWP} + 1}{2} ) - 14$$

most significant bits with value set to 0 (e.g., padding bits 430) after the offset bits 420-b and before the FDRA field (e.g., FDRA bits 415-b). That is, the resource allocation 405-b may be expanded from the set quantity of bits (e.g., 14 bits) to a new set quantity of bits

$$( e . g . , {log}_{2} ( {N}_{RB}^{UL , BWP} * \frac{{N}_{RB}^{UL , BWP} + 1}{2} ) )$$

in order to accommodate a greater quantity of FDRA bits 415-b. Excess bits of the resource allocation after the expansion may be the padding bits 430.

In some implementations, the resource allocation 405-b may be part of a DCI message, and may be a quantity of bits 410-b based on the size of the initial BWP

$$( {N}_{RB}^{UL , BWP , initial} ) .$$

For example, the quantity of bits 410-b may be

$${log}_{2} ( {N}_{RB}^{UL , BWP , initial} * \frac{{N}_{RB}^{UL , BWP , initial} + 1}{2} ) .$$

In some cases,

$${N}_{RB}^{UL , BWP}$$

may be greater than

$${N}_{RB}^{UL , BWP , initial} ,$$

and the resource allocation 405-b may be expanded to accommodate the FDRA field to include enough FDRA bits 415-b to cover all possible values of the virtual starting RB and lengths. For example, a wireless device, such as a UE or a network entity, may expand the FDRA field of the resource allocation 405-a such that the resource allocation 405-b may be

$${log}_{2} ( {N}_{RB}^{UL , BWP} * \frac{{N}_{RB}^{UL , BWP} + 1}{2} ) bits ,$$

and the FDRA bits 415-b may be

$${log}_{2} ( {N}_{RB}^{UL , BWP , initial} * \frac{{N}_{R B}^{UL , BWP , initial} + 1}{2} ) - {N}_{hop}^{UL}$$

least significant bits. The resource allocation 405-b may include the FDRA bits 415-b, which may be expanded based on

$${N}_{RB}^{UL , BWP} ,$$

and may include offset bits 420-b based on the

$${N}_{hop}^{UL} .$$

Padding bits 430 (e.g., bits with values set to 0) may be introduced between the offset bits 420-b and the FDRA bits 415-b, such that the expanded resource allocation 405-b may be

$${log}_{2} ( {N}_{RB}^{UL , BWP} * \frac{{N}_{RB}^{UL , BWP} + 1}{2} ) bits .$$

That is, the resource allocation 405-b may, after the expansion, include

$${log}_{2} ( {N}_{RB}^{UL , BWP} * \frac{{N}_{RB}^{UL , BWP} + 1}{2} ) - {log}_{2} ( {N}_{RB}^{UL , BWP , initial} * \frac{{N}_{R B}^{UL , BWP , initial} + 1}{2} )$$

most significant bits with value set to 0 (e.g., padding bits 430) after the offset bits 420-b and before the FDRA field (e.g., FDRA bits 415-b).

FIG. 5 shows an example of a block diagram 500 that supports frequency domain allocation for a random access message for SBFD communication in accordance with one or more aspects of the present disclosure. The block diagram 500 may implement, or be implemented by, aspects of the wireless communications systems 100 and 200, block diagram 300, and bit diagrams 400 and 401. For example, the block diagram 500 may include one or more initial uplink BWPs 505, active uplink BWPs 510, and usable uplink PRBs 515, which may be examples of corresponding frequency resources as described herein, including with reference to FIG. 3. The techniques described herein in the context of the block diagram 500 may support allocating transmission PRBs 520 for an uplink scheduled random access message within a set of usable uplink PRBs in accordance with SBFD.

In some implementations, a FDRA may be determined from an uplink grant based on a first PRB and a threshold quantity of PRBs, as described herein, including with reference to FIGS. 2 and 3. That is, the first PRB and the threshold quantity of PRBs may determine a range of possible frequency resources, and the allocated resources of the FDRA may be within the range of possible frequency resources. The allocated resources for the uplink scheduled random access message may be determined based on a RIV, which may be indicated in the random access response message or, for retransmissions of the uplink scheduled random access message, in a scheduling DCI. The FDRA may be defined using a starting RB (RBₛₜₐᵣₜ) (e.g., starting PRB), from which transmission may begin, and a length of allocation blocks (L_{RBs}), through which the transmission may extend.

In some implementations, as described with reference to FIGS. 4A and 4B, a quantity of FDRA bits may be determined based on a size of an active uplink BWP or a size of usable uplink PRBs, which may be denoted by

$${N}_{RB}^{UL , BWP} ( e . g . , {N}_{RB}^{UL , BWP}$$

may refer to the size of the active uplink BWP or the size of the usable uplink PRBs, in accordance with whether the active uplink BWP or the usable uplink PRBs are used as the reference). In SBFD symbols, a starting PRB and a length of allocation blocks may be derived from the

$${N}_{RB}^{UL , BWP}$$

and applied to the usable uplink PRBs. For example, the starting PRB and the length of allocation blocks may be derived based on one of Equations 2-5.

$${L}_{RBs} = {L}_{RBs}^{′} and {RB}_{start} = {RB}_{start}^{′} + A * {RB}_{offset} \qquad ( 2 )$$

$${L}_{RBs} = K * {L}_{RBs}^{′} and {RB}_{start} = K * {RB}_{start}^{′} + A * {RB}_{offset} \qquad ( 3 )$$

$${L}_{RBs} = {L}_{RBs}^{′} and {RB}_{start} = K * {RB}_{start}^{′} + A * {RB}_{offset} \qquad ( 4 )$$

$${L}_{RBs} = K * {L}_{RBs}^{′} and {RB}_{start} = {RB}_{start}^{′} + A * {RB}_{offset} \qquad ( 5 )$$

L′_{RBs} and

$${RB}_{start}^{′}$$

may be the length of allocation blocks and the starting PRB determined based on the RIV, as in Equation 6.

$$if {L}_{RBs}^{′} \leq \frac{{N}_{RB}^{UL , BWP}}{2} , then RIV = {N}_{RB}^{UL , BWP} ( {L}_{RBs}^{′} - 1 ) + {RB}_{start}^{′} else : RIV = {N}_{RB}^{UL , BWP} ( {N}_{RB}^{UL , BWP} - {L}_{RBS}^{′} + 1 ) + {N}_{RB}^{UL , BWP} - 1 - {RB}_{start}^{′} \qquad ( 6 )$$

L′_{RBs} may not exceed

$${N}_{RB}^{UL , BWP} - {RB}_{start}^{′} .$$

### L′_{RBs} and

$${RB}_{start}^{′}$$

may be scaled or offset using K, A, and RB_{offset}, as in Equations 2-5. K may be an integer scaling value that may be chosen such that L_{RBs} may be less than or equal to the size of the usable uplink

$$PRBs ( {N}_{RB}^{UL , BWP , unsable} ) ( e . g . , K \leq \frac{{N}_{RB}^{UL , BWP , usab1e}}{{N}_{RB}^{UL , BWP , initial}}$$

for a scheduling DCI, for example). RB_{offset} may be an RRC configured offset. A may be either 0 or 1 (e.g., A may activate or deactivate the offset (RB_{offset})). L_{RBs} and RBₛₜₐᵣₜ may be the virtual starting RB and length of allocation blocks indicating the transmission PRBs 520 used for transmission of the uplink scheduled random access message.

For example, the size of the usable uplink PRBs 515 may be four times the size of the initial uplink BWP 505

$$( e . g . , \frac{{N}_{RB}^{UL , BWP , usab1e}}{{N}_{RB}^{UL , BWP , initial}} = 4 ) .$$

In this example, the first PRB may be the first PRB in the usable uplink PRBs (e.g., as described with respect to FIG. 3) and the FDRA of the uplink grant may indicate a RIV that may be used to determine that L′_{RBs}=20 and

$${RB}_{start}^{′} = 10 .$$

That is, without any scaling or offset (e.g., K=1, A=0), the transmission PRBs 520-a may begin 10 PRBs after the first PRB of the usable uplink PRBs 515 and extend 20 PRBs in frequency. Additionally, or alternatively, a scaling factor may be introduced for the length of allocation RBs and not an offset (e.g., K=2, A=0), as in transmission PRBs 520-b. Additionally, or alternatively, an offset may be introduced and not a scaling factor (e.g., K=0, A=1), as in transmission PRBs 520-c. Additionally, or alternatively, a scaling factor may be introduced for the length of allocation RBs and an offset may be introduced (e.g., K=2, A=1), as in transmission PRBs 520-d. Additionally, or alternatively, a scaling factor may be introduced for both the length of allocation RBs and the starting RB, in addition to an offset that may be introduced (e.g., K=2, A=1), as in transmission PRBs 520-e. That is, by introducing scaling factors and offsets, the allocated resources determined by the RIV may be adjusted or moved within the usable uplink PRBs 515.

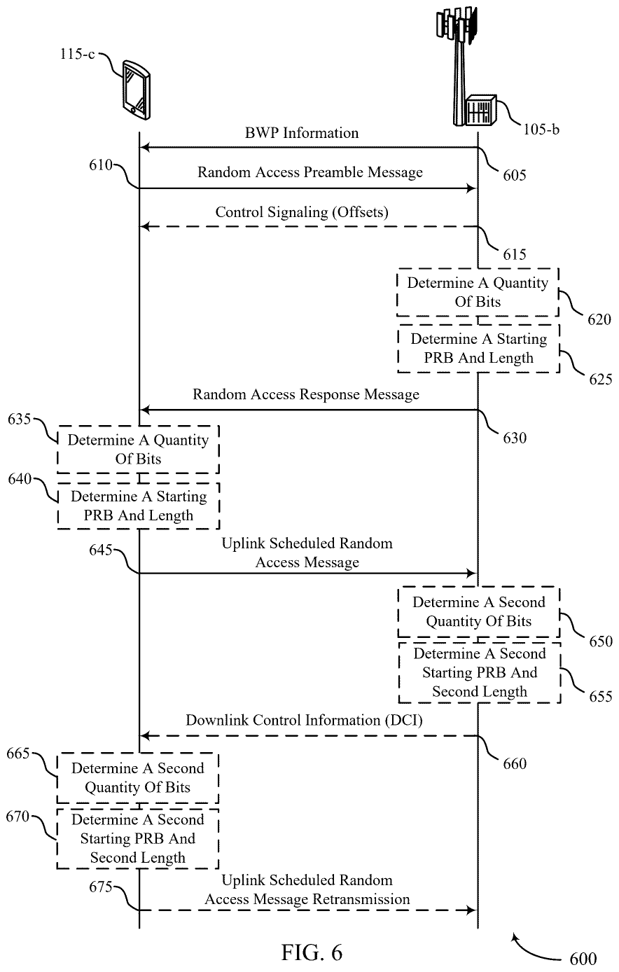

FIG. 6 shows an example of a process flow 600 that supports frequency domain allocation for a random access message for SBFD communication in accordance with one or more aspects of the present disclosure. The process flow 600 may implement, or be implemented by, aspects of the wireless communications systems 100 and 200, block diagrams 300 and 500, and bit diagrams 400 and 401. For example, the process flow 600 may include one or more network entities 105 and UEs 115, including at least the network entity 105-b and the UE 115-c, which may be examples of corresponding devices as described herein, including with reference to FIGS. 1 and 2. The techniques described herein in the context of the process flow 600 may support allocating frequency resources for an uplink scheduled random access message within a set of usable uplink PRBs in accordance with SBFD communication at the network entity 105-b.

At 605, the UE 115-c may receive, from the network entity 105-b, information indicative of an initial uplink BWP, an active uplink BWP, or both. For example, the information may include a SIB that may configure the initial uplink BWP, the active uplink BWP, or any combination thereof. Additionally, or alternatively, the information may include multiple messages (e.g., SIB, RRC) that may configure or indicate the initial uplink BWP and the active uplink BWP.

At 610, the UE 115-c may transmit, and the network entity 105-b may receive, a random access preamble message (e.g., Msg1) as part of an access procedure.

In some implementations, at 615, the UE 115-c may receive, and the network entity 105-b may transmit, control signaling that indicates one or more offsets, where a first PRB may be offset from a reference PRB based on an offset of the one or more offsets. Although the control signaling may be depicted in process flow 600 at 615, the control signaling may be received at any point in the process flow 600. For example, the control signaling may be received prior or in conjunction with the BWP information described at 605, or after receiving the random access response message, as described at 630.

In some implementations, at 620, the network entity 105-b may determine a quantity of bits associated with an FDRA portion of an uplink grant. In some cases, the quantity of bits associated with the FDRA portion of the uplink grant may be based on the set of usable uplink PRBs or the active uplink BWP. In some cases, a quantity of PRBs associated with the uplink grant may be less than a first threshold and the network entity 105-b may determine a quantity of bits associated with a FDRA portion of the uplink grant such that the quantity of bits is equal to a threshold quantity of bits associated with the FDRA portion of the uplink grant.

In some implementations, at 625, the network entity 105-b may determine a starting PRB in accordance with the FDRA portion of the uplink grant. That is, the uplink grant may be indicative of a RIV and the network entity 105-b may determine the starting PRB and a set of PRBs (e.g., based on the length of the allocated RBs) based on the RIV, where reception of an uplink scheduled random access message at 645 may use the set of PRBs, which may be based on a first PRB and the starting PRB. The set of PRBs may also be based on the length of the allocated PRBs.

At 625, the UE 115-c may receive, and the network entity 105-b may transmit, a random access response message. That is, the UE 115-c may receive, in response to transmission of the random access preamble message at 610, a random access response message, which may include an uplink grant. In some cases, the network entity 105-b may transmit the random access response message based on determining the quantity of bits at 620 and determining the starting PRB and length at 625. For example, the random access response message may be transmitted with the determined quantity of bits for the FDRA portion of the uplink grant and may indicate the determined starting PRB and the determined length of the allocated PRBs (e.g., the determined set of PRBs) (e.g., via the RIV).

In some implementations, at 635, the UE 115-c may determine the quantity of bits associated with a FDRA portion of the uplink grant. In some cases, the quantity of bits associated with the FDRA portion of the uplink grant may be based on the set of usable uplink PRBs or the active uplink BWP. That is, the FDRA field of an uplink grant may be expanded or truncated based on the set of usable uplink PRBs or the active uplink BWP, as described further with reference to FIGS. 4A and 4B. In some cases, a quantity of PRBs associated with the uplink grant may be less than a first threshold and the UE 115-c may determine a quantity of bits associated with the FDRA portion of the uplink grant such that the quantity of bits may be equal to a threshold quantity of bits associated with the FDRA portion of the uplink grant. That is, the FDRA field of a truncated uplink grant may be increased to fill all available bits of the uplink grant, as described further with reference to FIG. 4A.

In some implementations, at 640, the UE 115-c may determine the starting PRB in accordance with the FDRA portion of the uplink grant. That is, the uplink grant may be indicative of a RIV and the UE 115-c may determine the starting PRB and a set of PRBs (e.g., based on the length of the allocated RBs) based on the RIV, where transmission of the uplink scheduled random access message at 645 may use the set of PRBs, which may be based on the first PRB and the starting PRB. The set of PRBs may also be based on the length of the allocated PRBs.

At 645, the UE 115-c may transmit, and the network entity 105-b may receive, the uplink scheduled random access message (e.g., Msg3). That is, the UE 115-b may transmit, responsive to the uplink grant and based on a first PRB, the uplink scheduled random access message. Transmission of the uplink scheduled random access message may be within a set of usable uplink PRBs, where the set of usable uplink PRBs may be based on the active uplink BWP and an uplink sub-band associated with an SBFD configuration at the UE 115-c. Transmission of the uplink scheduled random access message may be within the set of usable uplink PRBs based on the first PRB being within the set of usable uplink PRBs or being offset from a reference PRB. The reference PRB may be associated with the initial uplink BWP or with the active uplink BWP. The offset may be indicated via control signaling at 615. In some cases, the UE 115-c may transmit the uplink scheduled random access message using a set of PRBS that may be within the set of usable uplink PRBs. The set of PRBs may be positioned within the set of usable uplink PRBs in accordance with one or more scaling factors, one or more offsets, or any combination thereof, as described further with reference to FIG. 5. In some cases, the first PRB may be associated with a lowest frequency of the set of usable uplink PRBs. In some cases, the reference PRB may be associated with a lowest frequency within the initial uplink BWP or may be associated with a lowest frequency within the active uplink BWP.

In some implementations, at 650, the network entity 105-b may determine a second quantity of bits associated with an FDRA portion of a second uplink grant. In some cases, a quantity of PRBs associated with the second uplink grant may be less than a first threshold, and the network entity 105-b may determine the second quantity of bits (e.g., quantity of bits) associated with the FDRA portion of the second uplink grant such that the second quantity of bits may be equal to the threshold quantity of bits associated with the FDRA portion of the second uplink grant.

In some implementations, at 655, the network entity 105-b may determine a second starting PRB. That is, the second uplink grant may be indicative of a second RIV and the network entity 105-b may determine the second starting PRB and a second set of PRBs (e.g., based on a second length of the allocated RBs) based on the second RIV, where reception of the uplink scheduled random access message retransmission at 675 may use the second set of PRBs, which may be based on the first PRB and the second starting PRB. The second set of PRBs may also be based on the length of allocated PRBs

In some implementations, at 660, the UE 115-c may receive, and the network entity 105-b may transmit, DCI based on the transmission of the uplink scheduled random access message at 645. The DCI may include a second uplink grant for retransmission of the uplink scheduled random access message. In some cases, the network entity 105-b may transmit the DCI based on determining the second quantity of bits at 650 and determining the second starting PRB and second length at 655. For example, the DCI may be transmitted with the determined second quantity of bits for the FDRA portion of the uplink grant and may indicate the second determined starting PRB and the second determined length of the allocated PRBs (e.g., the determined set of PRBs) (e.g., via the RIV).

In some implementations, at 665, the UE 115-c may determine a second quantity of bits associated with an FDRA portion of a second uplink grant. In some cases, a quantity of PRBs associated with the second uplink grant may be less than a first threshold, and the UE 115-c may determine the second quantity of bits (e.g., quantity of bits) associated with a FDRA portion of the second uplink grant such that the second quantity of bits is equal to a threshold quantity of bits associated with the FDRA portion of the second uplink grant.

In some implementations, at 670, the UE 115-c may determine a second starting PRB in accordance with the FDRA portion of the second uplink grant. That is, the second uplink grant may be indicative of a second RIV and the UE 115-c may determine the second starting PRB and a second set of PRBs (e.g., based on a second length of the allocated PRBs) based on the second RIV, where transmission of the uplink scheduled random access message retransmission at 675 may use the second set of PRBs, which may be based on the first PRB and the second starting PRB. The second set of PRBs may also be based on the length of allocated PRBs.

In some implementations, at 675, the UE 115-c may retransmit, and the network entity 105-b may receive, the uplink scheduled random access message. That is, the UE 115-c may retransmit, responsive to the second uplink grant and based on a second PRB, the uplink scheduled random access message as a retransmitted uplink scheduled random access message. Transmission of the retransmitted uplink scheduled random access message may be within a second set of usable uplink PRBs, the second set of usable uplink PRBs based on a second active uplink BWP and the uplink sub-band associated with the SBFD configuration at the UE 115-c. Transmission of the retransmitted uplink scheduled random access message may be within the second set of usable uplink PRBs based on the second PRB being within the second set of usable uplink PRBs or being offset from a second reference PRB. The second reference PRB may be associated with the initial uplink BWP or with the second active uplink BWP.

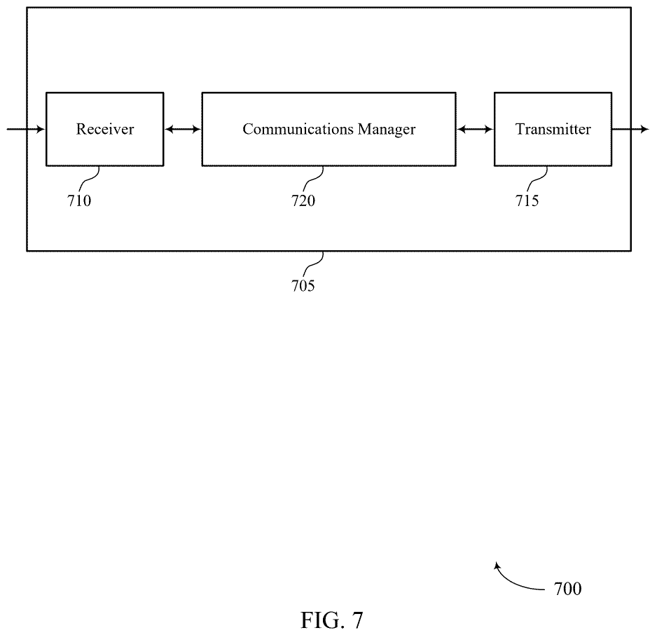

FIG. 7 shows a block diagram 700 of a device 705 that supports frequency domain allocation for a random access message for SBFD communication in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to frequency domain allocation for a random access message for SBFD communication). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to frequency domain allocation for a random access message for SBFD communication). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of frequency domain allocation for a random access message for SBFD communication as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for receiving information indicative of an initial uplink BWP, an active uplink BWP, or both. The communications manager 720 is capable of, configured to, or operable to support a means for transmitting, as part of an access procedure, a random access preamble message. The communications manager 720 is capable of, configured to, or operable to support a means for receiving, in response to transmission of the random access preamble message, a random access response message including an uplink grant. The communications manager 720 is capable of, configured to, or operable to support a means for transmitting, responsive to the uplink grant and based on a first PRB, an uplink scheduled random access message, where transmission of the uplink scheduled random access message is within a set of usable uplink PRBs, the set of usable uplink PRBs based on the active uplink BWP and an uplink sub-band associated with SBFD configuration, and transmission of the uplink scheduled random access message within the set of usable uplink PRBs is based on the first PRB being within the set of usable uplink PRBs or being offset from a reference PRB, where the reference PRB is associated with the initial uplink BWP or with the active uplink BWP.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for more efficient utilization of communication resources, reduced latency, and reduced processing time.

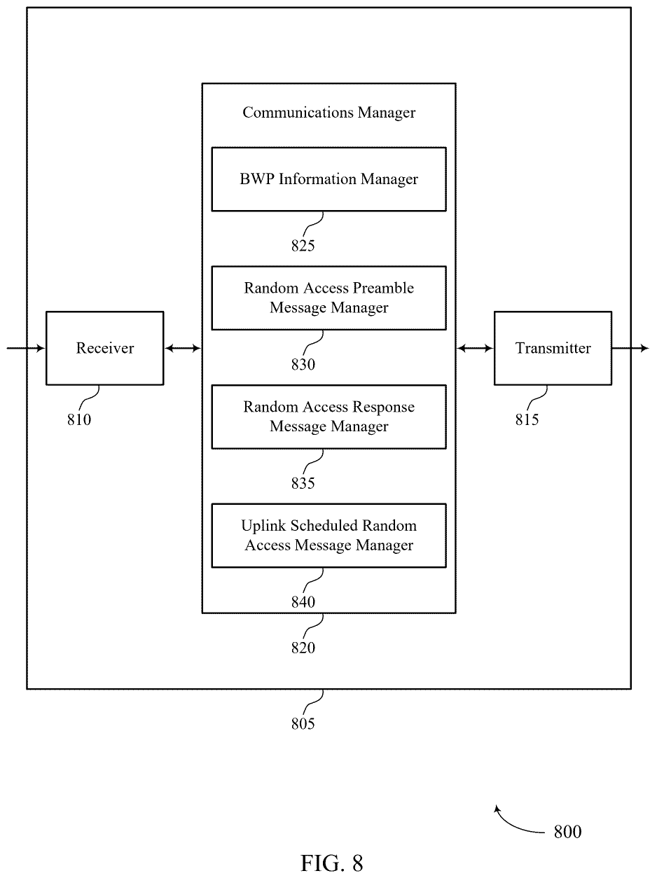

FIG. 8 shows a block diagram 800 of a device 805 that supports frequency domain allocation for a random access message for SBFD communication in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to frequency domain allocation for a random access message for SBFD communication). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to frequency domain allocation for a random access message for SBFD communication). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of frequency domain allocation for a random access message for SBFD communication as described herein. For example, the communications manager 820 may include a BWP information manager 825, a random access preamble message manager 830, a random access response message manager 835, an uplink scheduled random access message manager 840, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The BWP information manager 825 is capable of, configured to, or operable to support a means for receiving information indicative of an initial uplink BWP, an active uplink BWP, or both. The random access preamble message manager 830 is capable of, configured to, or operable to support a means for transmitting, as part of an access procedure, a random access preamble message. The random access response message manager 835 is capable of, configured to, or operable to support a means for receiving, in response to transmission of the random access preamble message, a random access response message including an uplink grant. The uplink scheduled random access message manager 840 is capable of, configured to, or operable to support a means for transmitting, responsive to the uplink grant and based on a first PRB, an uplink scheduled random access message, where transmission of the uplink scheduled random access message is within a set of usable uplink PRBs, the set of usable uplink PRBs based on the active uplink BWP and an uplink sub-band associated with a SBFD configuration at the UE and transmission of the uplink scheduled random access message within the set of usable uplink PRBs is based on the first PRB being within the set of usable uplink PRBs or being offset from a reference PRB, where the reference PRB is associated with the initial uplink BWP or with the active uplink BWP.

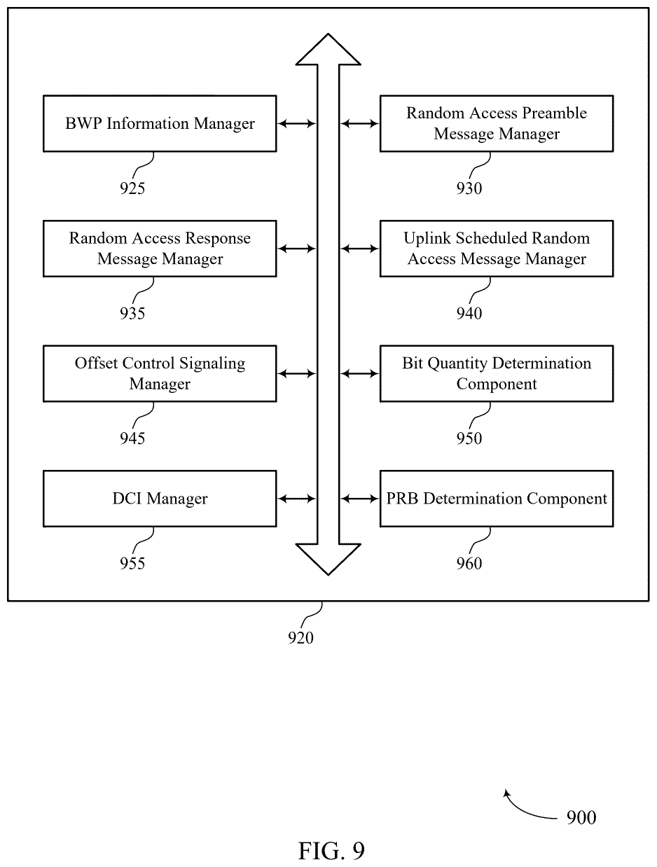

FIG. 9 shows a block diagram 900 of a communications manager 920 that supports frequency domain allocation for a random access message for SBFD communication in accordance with one or more aspects of the present disclosure. The communications manager 920 may be an example of aspects of a communications manager 720, a communications manager 820, or both, as described herein. The communications manager 920, or various components thereof, may be an example of means for performing various aspects of frequency domain allocation for a random access message for SBFD communication as described herein. For example, the communications manager 920 may include a BWP information manager 925, a random access preamble message manager 930, a random access response message manager 935, an uplink scheduled random access message manager 940, an offset control signaling manager 945, a bit quantity determination component 950, a DCI manager 955, an PRB determination component 960, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The BWP information manager 925 is capable of, configured to, or operable to support a means for receiving information indicative of an initial uplink BWP, an active uplink BWP, or both. The random access preamble message manager 930 is capable of, configured to, or operable to support a means for transmitting, as part of an access procedure, a random access preamble message. The random access response message manager 935 is capable of, configured to, or operable to support a means for receiving, in response to transmission of the random access preamble message, a random access response message including an uplink grant. The uplink scheduled random access message manager 940 is capable of, configured to, or operable to support a means for transmitting, responsive to the uplink grant and based on a first PRB, an uplink scheduled random access message, where transmission of the uplink scheduled random access message is within a set of usable uplink PRBs, the set of usable uplink PRBs based on the active uplink BWP and an uplink sub-band associated with a SBFD configuration at the UE and transmission of the uplink scheduled random access message within the set of usable uplink PRBs is based on the first PRB being within the set of usable uplink PRBs or being offset from a reference PRB, where the reference PRB is associated with the initial uplink BWP or with the active uplink BWP.

In some examples, the offset control signaling manager 945 is capable of, configured to, or operable to support a means for receiving control signaling that indicates one or more offsets, where the first PRB is offset from the reference PRB based on an offset of the one or more offsets.

In some examples, the first PRB is associated with a lowest frequency of the set of usable uplink PRBs.

In some examples, the reference PRB is associated with a lowest frequency within the initial uplink BWP or is associated with a lowest frequency within the active uplink BWP.

In some examples, a quantity of bits associated with a FDRA portion of the uplink grant is based on the set of usable uplink PRBs or the active uplink BWP.

In some examples, a quantity of PRBs associated with the uplink grant is less than a first threshold, and the bit quantity determination component 950 is capable of, configured to, or operable to support a means for determining a quantity of bits associated with a FDRA portion of the uplink grant such that the quantity of bits is equal to a threshold quantity of bits associated with the FDRA portion of the uplink grant.

In some examples, to support transmitting the uplink scheduled random access message, the uplink scheduled random access message manager 940 is capable of, configured to, or operable to support a means for transmitting the uplink scheduled random access message using a set of multiple PRBs that are within the set of usable uplink PRBs, the set of multiple PRBs positioned within the set of usable uplink PRBs in accordance with one or more scaling factors, one or more offsets, or any combination thereof.

In some examples, the uplink grant is indicative of a RIV, and the PRB determination component 960 is capable of, configured to, or operable to support a means for determining a starting PRB and the set of multiple PRBs based on the RIV, where transmission of the uplink scheduled random access message using the set of multiple PRBs is based on the first PRB and the starting PRB.

In some examples, the DCI manager 955 is capable of, configured to, or operable to support a means for receiving DCI based on transmitting the uplink scheduled random access message, where the DCI includes a second uplink grant for retransmission of the uplink scheduled random access message. In some examples, the uplink scheduled random access message manager 940 is capable of, configured to, or operable to support a means for retransmitting, responsive to the second uplink grant and based on a second PRB, the uplink scheduled random access message as a retransmitted uplink scheduled random access message, where transmission of the retransmitted uplink scheduled random access message is within a second set of usable uplink PRBs, the second set of usable uplink PRBs based on a second active uplink BWP and the uplink sub-band associated with the SBFD configuration at the UE and transmission of the retransmitted uplink scheduled random access message within the second set of usable uplink PRBs is based on the second PRB being within the second set of usable uplink PRBs or being offset from a second reference PRB, where the second reference PRB is associated with the initial uplink BWP or with the second active uplink BWP.

In some examples, a quantity of bits associated with a FDRA portion of the uplink grant is based on the second set of usable uplink PRBs or the active uplink BWP.

In some examples, a quantity of PRBs associated with the second uplink grant is less than a first threshold, and the bit quantity determination component 950 is capable of, configured to, or operable to support a means for determining a quantity of bits associated with a FDRA portion of the second uplink grant such that the quantity of bits is equal to a threshold quantity of bits associated with the FDRA portion of the second uplink grant.

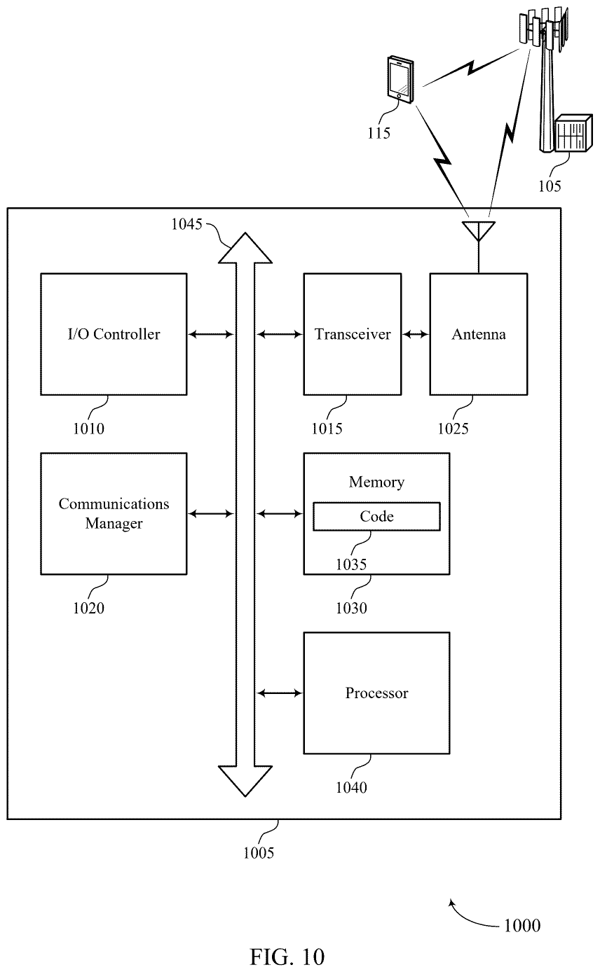

FIG. 10 shows a diagram of a system 1000 including a device 1005 that supports frequency domain allocation for a random access message for SBFD communication in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting frequency domain allocation for a random access message for SBFD communication). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for receiving information indicative of an initial uplink BWP, an active uplink BWP, or both. The communications manager 1020 is capable of, configured to, or operable to support a means for transmitting, as part of an access procedure, a random access preamble message. The communications manager 1020 is capable of, configured to, or operable to support a means for receiving, in response to transmission of the random access preamble message, a random access response message including an uplink grant. The communications manager 1020 is capable of, configured to, or operable to support a means for transmitting, responsive to the uplink grant and based on a first PRB, an uplink scheduled random access message, where transmission of the uplink scheduled random access message is within a set of usable uplink PRBs, the set of usable uplink PRBs based on the active uplink BWP and an uplink sub-band associated with a SBFD configuration at the UE and transmission of the uplink scheduled random access message within the set of usable uplink PRBs is based on the first PRB being within the set of usable uplink PRBs or being offset from a reference PRB, where the reference PRB is associated with the initial uplink BWP or with the active uplink BWP.

By including or configuring the communications manager 1020 in accordance with examples as described herein, the device 1005 may support techniques for improved communication reliability, reduced latency, more efficient utilization of communication resources, improved coordination between devices, and improved utilization of processing capability.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of frequency domain allocation for a random access message for SBFD communication as described herein, or the at least one processor 1040 and the at least one memory 1030 may be otherwise configured to, individually or collectively, perform or support such operations.

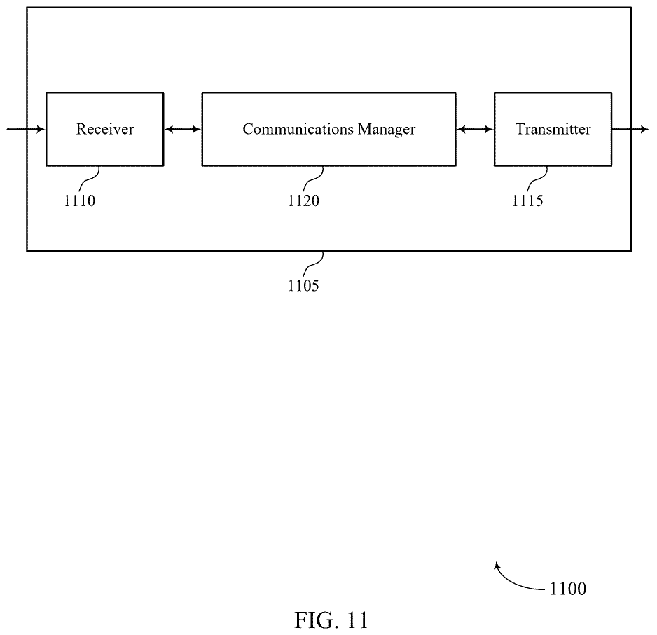

FIG. 11 shows a block diagram 1100 of a device 1105 that supports frequency domain allocation for a random access message for SBFD communication in accordance with one or more aspects of the present disclosure. The device 1105 may be an example of aspects of a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations or components thereof may be examples of means for performing various aspects of frequency domain allocation for a random access message for SBFD communication as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor (e.g., referred to as a processor-executable code). If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. For example, the communications manager 1120 is capable of, configured to, or operable to support a means for transmitting information indicative of an initial uplink BWP, an active uplink BWP, or both. The communications manager 1120 is capable of, configured to, or operable to support a means for receiving, as part of an access procedure, a random access preamble message. The communications manager 1120 is capable of, configured to, or operable to support a means for transmitting, in response to reception of the random access preamble message, a random access response message including an uplink grant. The communications manager 1120 is capable of, configured to, or operable to support a means for receiving, responsive to the uplink grant and based on a first PRB, an uplink scheduled random access message, where reception of the uplink scheduled random access message is within a set of usable uplink PRBs, the set of usable uplink PRBs based on the active uplink BWP and an uplink sub-band associated with a SBFD configuration and reception of the uplink scheduled random access message within the set of usable uplink PRBs is based on the first PRB being within the set of usable uplink PRBs or being offset from a reference PRB, where the reference PRB is associated with the initial uplink BWP or with the active uplink BWP.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for reduced processing time, reduced latency, and more efficient utilization of communication resources.

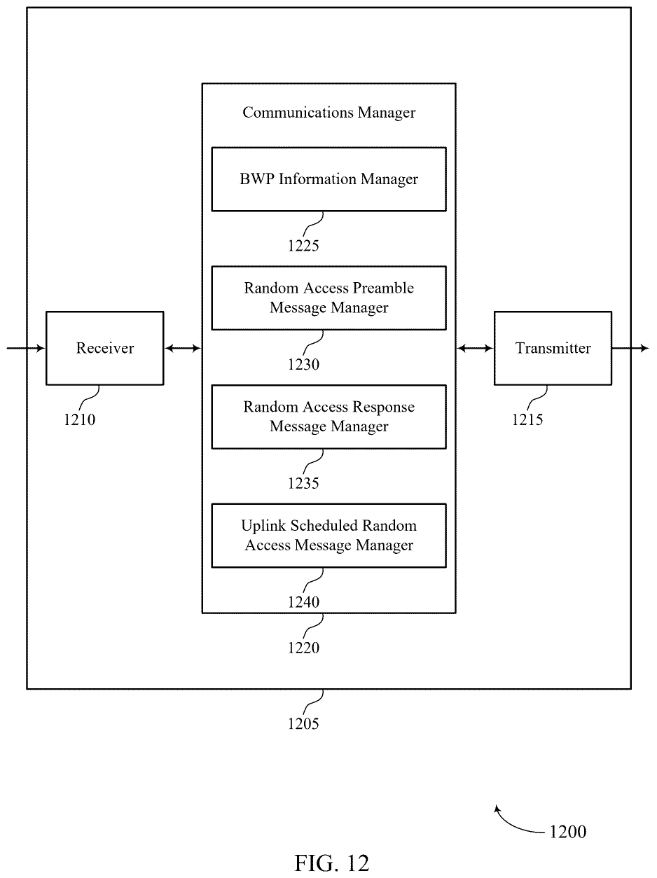

FIG. 12 shows a block diagram 1200 of a device 1205 that supports frequency domain allocation for a random access message for SBFD communication in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of frequency domain allocation for a random access message for SBFD communication as described herein. For example, the communications manager 1220 may include a BWP information manager 1225, a random access preamble message manager 1230, a random access response message manager 1235, an uplink scheduled random access message manager 1240, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. The BWP information manager 1225 is capable of, configured to, or operable to support a means for transmitting information indicative of an initial uplink BWP, an active uplink BWP, or both. The random access preamble message manager 1230 is capable of, configured to, or operable to support a means for receiving, as part of an access procedure, a random access preamble message. The random access response message manager 1235 is capable of, configured to, or operable to support a means for transmitting, in response to reception of the random access preamble message, a random access response message including an uplink grant. The uplink scheduled random access message manager 1240 is capable of, configured to, or operable to support a means for receiving, responsive to the uplink grant and based on a first PRB, an uplink scheduled random access message, where reception of the uplink scheduled random access message is within a set of usable uplink PRBs, the set of usable uplink PRBs based on the active uplink BWP and an uplink sub-band associated with a SBFD configuration and reception of the uplink scheduled random access message within the set of usable uplink PRBs is based on the first PRB being within the set of usable uplink PRBs or being offset from a reference PRB, where the reference PRB is associated with the initial uplink BWP or with the active uplink BWP.

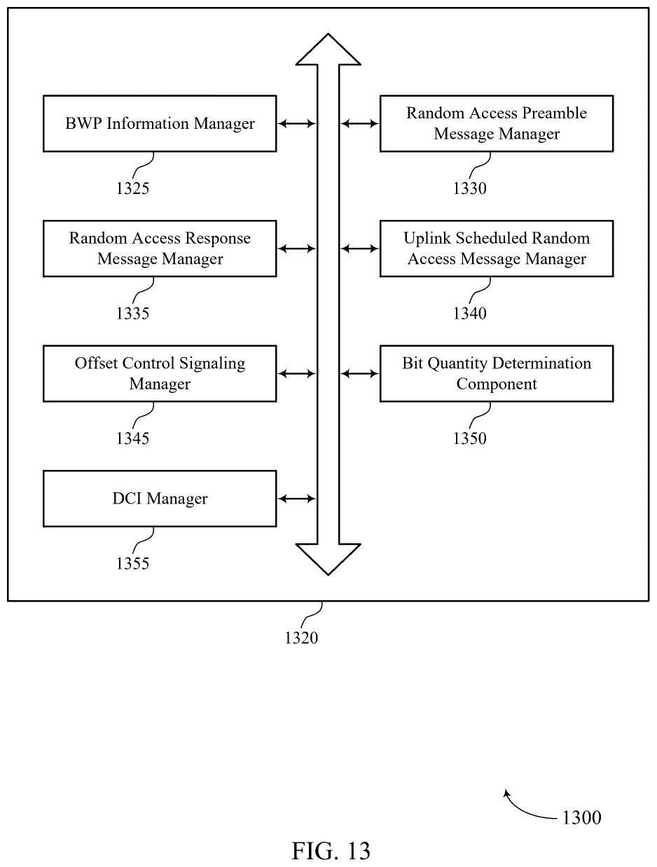

FIG. 13 shows a block diagram 1300 of a communications manager 1320 that supports frequency domain allocation for a random access message for SBFD communication in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of frequency domain allocation for a random access message for SBFD communication as described herein. For example, the communications manager 1320 may include a BWP information manager 1325, a random access preamble message manager 1330, a random access response message manager 1335, an uplink scheduled random access message manager 1340, an offset control signaling manager 1345, a bit quantity determination component 1350, a DCI manager 1355, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications in accordance with examples as disclosed herein. The BWP information manager 1325 is capable of, configured to, or operable to support a means for transmitting information indicative of an initial uplink BWP, an active uplink BWP, or both. The random access preamble message manager 1330 is capable of, configured to, or operable to support a means for receiving, as part of an access procedure, a random access preamble message. The random access response message manager 1335 is capable of, configured to, or operable to support a means for transmitting, in response to reception of the random access preamble message, a random access response message including an uplink grant. The uplink scheduled random access message manager 1340 is capable of, configured to, or operable to support a means for receiving, responsive to the uplink grant and based on a first PRB, an uplink scheduled random access message, where reception of the uplink scheduled random access message is within a set of usable uplink PRBs, the set of usable uplink PRBs based on the active uplink BWP and an uplink sub-band associated with a SBFD configuration and reception of the uplink scheduled random access message within the set of usable uplink PRBs is based on the first PRB being within the set of usable uplink PRBs or being offset from a reference PRB, where the reference PRB is associated with the initial uplink BWP or with the active uplink BWP.

In some examples, the offset control signaling manager 1345 is capable of, configured to, or operable to support a means for transmitting control signaling that indicates one or more offsets, where the first PRB is offset from the reference PRB based on an offset of the one or more offsets.

In some examples, the first PRB is associated with a lowest frequency of the set of usable uplink PRBs.

In some examples, the reference PRB is associated with a lowest frequency within the initial uplink BWP or is associated with a lowest frequency within the active uplink BWP.

In some examples, a quantity of bits associated with a FDRA portion of the uplink grant is based on the set of usable uplink PRBs or the active uplink BWP.

In some examples, a quantity of PRBs associated with the uplink grant is less than a first threshold and the bit quantity determination component 1350 is capable of, configured to, or operable to support a means for determining a quantity of bits associated with a FDRA portion of the uplink grant such that the quantity of bits is equal to a threshold quantity of bits associated with the FDRA portion of the uplink grant.

In some examples, to support receiving the uplink scheduled random access message, the uplink scheduled random access message manager 1340 is capable of, configured to, or operable to support a means for receiving the uplink scheduled random access message using a set of multiple PRBs that are within the set of usable uplink PRBs, the set of multiple PRBs positioned within the set of usable uplink PRBs in accordance with one or more scaling factors, one or more offsets, or any combination thereof.

In some examples, the uplink grant is indicative of a RIV, the RIV associated with a starting PRB and the set of multiple PRBs. In some examples, reception of the uplink scheduled random access message using the set of multiple PRBs is based on the first PRB and the starting PRB.

In some examples, the DCI manager 1355 is capable of, configured to, or operable to support a means for transmitting DCI based on transmitting the uplink scheduled random access message, where the DCI includes a second uplink grant for retransmission of the uplink scheduled random access message. In some examples, the uplink scheduled random access message manager 1340 is capable of, configured to, or operable to support a means for receiving, responsive to the second uplink grant and based on a second PRB, the uplink scheduled random access message as a retransmitted uplink scheduled random access message, where reception of the retransmitted uplink scheduled random access message is within a second set of usable uplink PRBs, the second set of usable uplink PRBs based on a second active uplink BWP and the uplink sub-band associated with the SBFD configuration and reception of the retransmitted uplink scheduled random access message within the second set of usable uplink PRBs is based on the second PRB being within the second set of usable uplink PRBs or being offset from a second reference PRB, where the second reference PRB is associated with the initial uplink BWP or with the second active uplink BWP.

In some examples, a quantity of bits associated with a FDRA portion of the uplink grant is based on the second set of usable uplink PRBs or the active uplink BWP.

In some examples, a quantity of PRBs associated with the second uplink grant is less than a first threshold, and the bit quantity determination component 1350 is capable of, configured to, or operable to support a means for determining a quantity of bits associated with a FDRA portion of the second uplink grant such that the quantity of bits is equal to a threshold quantity of bits associated with the FDRA portion of the second uplink grant.

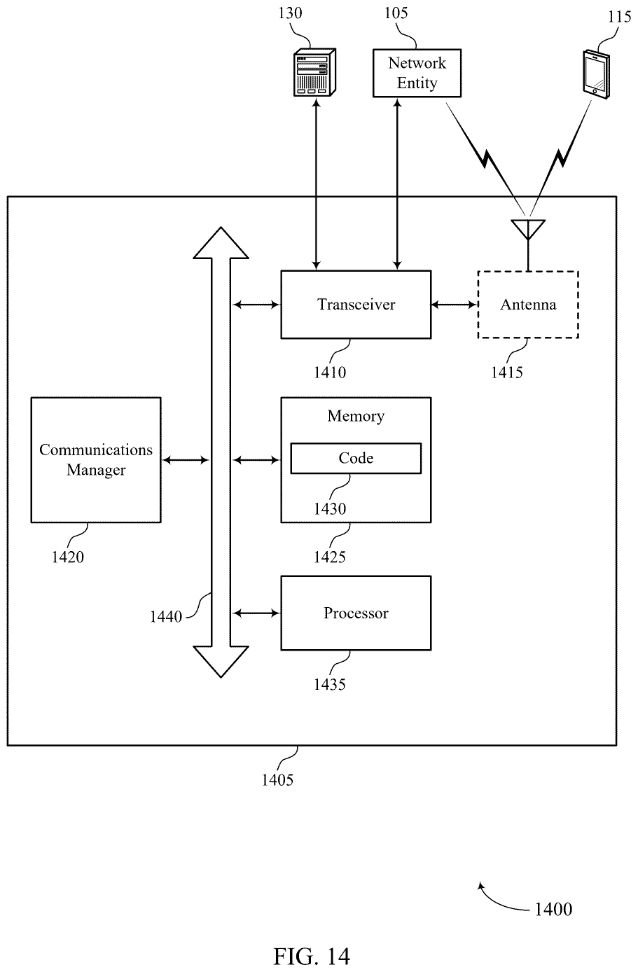

FIG. 14 shows a diagram of a system 1400 including a device 1405 that supports frequency domain allocation for a random access message for SBFD communication in accordance with one or more aspects of the present disclosure. The device 1405 may be an example of or include components of a device 1105, a device 1205, or a network entity 105 as described herein. The device 1405 may communicate with other network devices or network equipment such as one or more of the network entities 105, UEs 115, or any combination thereof. The communications may include communications over one or more wired interfaces, over one or more wireless interfaces, or any combination thereof. The device 1405 may include components that support outputting and obtaining communications, such as a communications manager 1420, a transceiver 1410, one or more antennas 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., communication link(s) 125, backhaul communication link(s) 120, a midhaul communication link 162, a fronthaul communication link 168).

The at least one memory 1425 may include RAM, ROM, or any combination thereof. The at least one memory 1425 may store computer-readable, computer-executable, or processor-executable code, such as the code 1430. The code 1430 may include instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may include, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting frequency domain allocation for a random access message for SBFD communication). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425).

In some examples, the at least one processor 1435 may include multiple processors and the at least one memory 1425 may include multiple memories. One or more of the multiple processors may be coupled with one or more of the multiple memories, which may, individually or collectively, be configured to perform various functions herein. In some examples, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. For example, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1425 or otherwise, to perform one or more of the functions described herein.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with one or more other network entities 105, and may include a controller or scheduler for controlling communications with UEs 115 (e.g., in cooperation with the one or more other network devices). In some examples, the communications manager 1420 may support an X2 interface within an LTE/LTE-A wireless communications network technology to provide communication between network entities 105.

The communications manager 1420 may support wireless communications in accordance with examples as disclosed herein. For example, the communications manager 1420 is capable of, configured to, or operable to support a means for transmitting information indicative of an initial uplink BWP, an active uplink BWP, or both. The communications manager 1420 is capable of, configured to, or operable to support a means for receiving, as part of an access procedure, a random access preamble message. The communications manager 1420 is capable of, configured to, or operable to support a means for transmitting, in response to reception of the random access preamble message, a random access response message including an uplink grant. The communications manager 1420 is capable of, configured to, or operable to support a means for receiving, responsive to the uplink grant and based on a first PRB, an uplink scheduled random access message, where reception of the uplink scheduled random access message is within a set of usable uplink PRBs, the set of usable uplink PRBs based on the active uplink BWP and an uplink sub-band associated with a SBFD configuration and reception of the uplink scheduled random access message within the set of usable uplink PRBs is based on the first PRB being within the set of usable uplink PRBs or being offset from a reference PRB, where the reference PRB is associated with the initial uplink BWP or with the active uplink BWP.

By including or configuring the communications manager 1420 in accordance with examples as described herein, the device 1405 may support techniques for improved communication reliability, reduced latency, more efficient utilization of communication resources, improved coordination between devices, and improved utilization of processing capability.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of frequency domain allocation for a random access message for SBFD communication as described herein, or the at least one processor 1435 and the at least one memory 1425 may be otherwise configured to, individually or collectively, perform or support such operations.

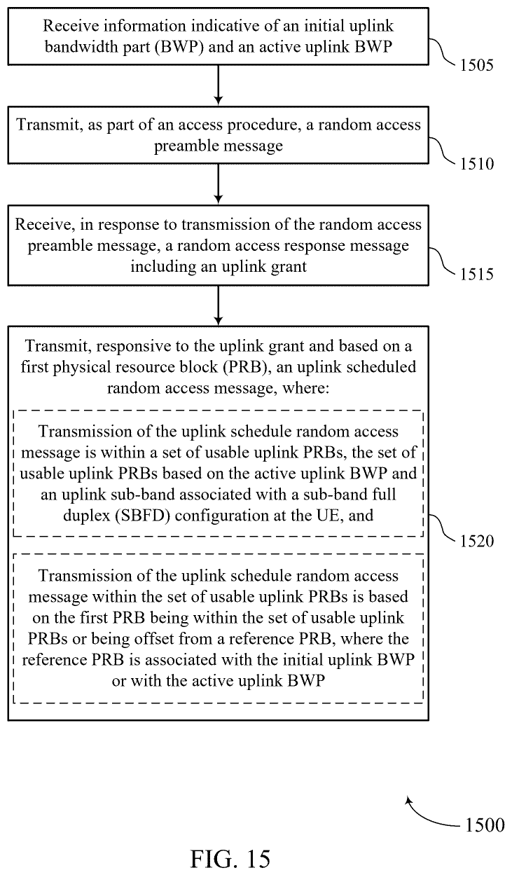

FIG. 15 shows a flowchart illustrating a method 1500 that supports frequency domain allocation for a random access message for SBFD communication in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving information indicative of an initial uplink BWP, an active uplink BWP, or both. The operations of 1505 may be performed in accordance with examples as disclosed herein. In some examples, aspects of the operations of 1505 may be performed by a BWP information manager 925 as described with reference to FIG. 9.

At 1510, the method may include transmitting, as part of an access procedure, a random access preamble message. The operations of 1510 may be performed in accordance with examples as disclosed herein. In some examples, aspects of the operations of 1510 may be performed by a random access preamble message manager 930 as described with reference to FIG. 9.

At 1515, the method may include receiving, in response to transmission of the random access preamble message, a random access response message including an uplink grant. The operations of 1515 may be performed in accordance with examples as disclosed herein. In some examples, aspects of the operations of 1515 may be performed by a random access response message manager 935 as described with reference to FIG. 9.

At 1520, the method may include transmitting, responsive to the uplink grant and based on a first PRB, an uplink scheduled random access message, where transmission of the uplink scheduled random access message is within a set of usable uplink PRBs, the set of usable uplink PRBs based on the active uplink BWP and an uplink sub-band associated with a SBFD configuration at the UE and transmission of the uplink scheduled random access message within the set of usable uplink PRBs is based on the first PRB being within the set of usable uplink PRBs or being offset from a reference PRB, where the reference PRB is associated with the initial uplink BWP or with the active uplink BWP. The operations of 1520 may be performed in accordance with examples as disclosed herein. In some examples, aspects of the operations of 1520 may be performed by an uplink scheduled random access message manager 940 as described with reference to FIG. 9.

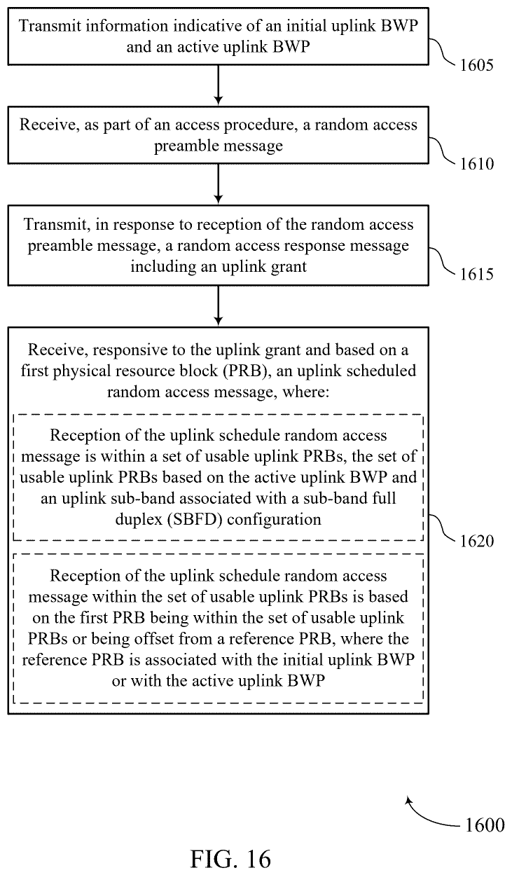

FIG. 16 shows a flowchart illustrating a method 1600 that supports frequency domain allocation for a random access message for SBFD communication in accordance with one or more aspects of the present disclosure. The operations of the method 1600 may be implemented by a network entity or its components as described herein. For example, the operations of the method 1600 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1605, the method may include transmitting information indicative of an initial uplink BWP, an active uplink BWP, or both. The operations of 1605 may be performed in accordance with examples as disclosed herein. In some examples, aspects of the operations of 1605 may be performed by a BWP information manager 1325 as described with reference to FIG. 13.

At 1610, the method may include receiving, as part of an access procedure, a random access preamble message. The operations of 1610 may be performed in accordance with examples as disclosed herein. In some examples, aspects of the operations of 1610 may be performed by a random access preamble message manager 1330 as described with reference to FIG. 13.

At 1615, the method may include transmitting, in response to reception of the random access preamble message, a random access response message including an uplink grant. The operations of 1615 may be performed in accordance with examples as disclosed herein. In some examples, aspects of the operations of 1615 may be performed by a random access response message manager 1335 as described with reference to FIG. 13.

At 1620, the method may include receiving, responsive to the uplink grant and based on a first PRB, an uplink scheduled random access message, where reception of the uplink scheduled random access message is within a set of usable uplink PRBs, the set of usable uplink PRBs based on the active uplink BWP and an uplink sub-band associated with a SBFD configuration and reception of the uplink scheduled random access message within the set of usable uplink PRBs is based on the first PRB being within the set of usable uplink PRBs or being offset from a reference PRB, where the reference PRB is associated with the initial uplink BWP or with the active uplink BWP. The operations of 1620 may be performed in accordance with examples as disclosed herein. In some examples, aspects of the operations of 1620 may be performed by an uplink scheduled random access message manager 1340 as described with reference to FIG. 13.

The following provides an overview of aspects of the present disclosure. The following aspects are given by way of illustration. Examples of the following aspects may be combined with examples or embodiments shown or discussed in relation to the figures or elsewhere herein.

Aspect 1: A method for wireless communications at a UE, comprising: receiving information indicative of an initial uplink BWP, an active uplink BWP, or both; transmitting, as part of an access procedure, a random access preamble message; receiving, in response to transmission of the random access preamble message, a random access response message comprising an uplink grant; and transmitting, responsive to the uplink grant and based at least in part on a first PRB, an uplink scheduled random access message, wherein transmission of the uplink scheduled random access message is within a set of usable uplink PRBs, the set of usable uplink PRBs based at least in part on the active uplink BWP and an uplink sub-band associated with a SBFD configuration at the UE, and wherein transmission of the uplink scheduled random access message within the set of usable uplink PRBs is based at least in part on the first PRB being within the set of usable uplink PRBs or being offset from a reference PRB, wherein the reference PRB is associated with the initial uplink BWP or with the active uplink BWP.

Aspect 2: The method of aspect 1, further comprising: receiving control signaling that indicates one or more offsets, wherein the first PRB is offset from the reference PRB based at least in part on an offset of the one or more offsets.

Aspect 3: The method of any of aspects 1 through 2, wherein the first PRB is associated with a lowest frequency of the set of usable uplink PRBs.

Aspect 4: The method of any of aspects 1 through 3, wherein the reference PRB is associated with a lowest frequency within the initial uplink BWP or is associated with a lowest frequency within the active uplink BWP.

Aspect 5: The method of any of aspects 1 through 4, wherein a quantity of bits associated with a FDRA portion of the uplink grant is based at least in part on the set of usable uplink PRBs or the active uplink BWP.

Aspect 6: The method of any of aspects 1 through 5, wherein a quantity of PRBs associated with the uplink grant is less than a first threshold, and wherein the method further comprises: determining a quantity of bits associated with a FDRA portion of the uplink grant such that the quantity of bits is equal to a threshold quantity of bits associated with the FDRA portion of the uplink grant.

Aspect 7: The method of any of aspects 1 through 6, wherein transmitting the uplink scheduled random access message comprises: transmitting the uplink scheduled random access message using a plurality of PRBs that are within the set of usable uplink PRBs, the plurality of PRBs positioned within the set of usable uplink PRBs in accordance with one or more scaling factors, one or more offsets, or any combination thereof.

Aspect 8: The method of aspect 7, wherein the uplink grant is indicative of a RIV, the method further comprising: determining a starting PRB and the plurality of PRBs based at least in part on the RIV, wherein transmission of the uplink scheduled random access message using the plurality of PRBs is based at least in part on the first PRB and the starting PRB.

Aspect 9: The method of any of aspects 1 through 8, further comprising: receiving DCI based at least in part on transmitting the uplink scheduled random access message, wherein the DCI includes a second uplink grant for retransmission of the uplink scheduled random access message; and retransmitting, responsive to the second uplink grant and based at least in part on a second PRB, the uplink scheduled random access message as a retransmitted uplink scheduled random access message, wherein transmission of the retransmitted uplink scheduled random access message is within a second set of usable uplink PRBs, the second set of usable uplink PRBs based at least in part on a second active uplink BWP and the uplink sub-band associated with the SBFD configuration at the UE, and wherein transmission of the retransmitted uplink scheduled random access message within the second set of usable uplink PRBs is based at least in part on the second PRB being within the second set of usable uplink PRBs or being offset from a second reference PRB, wherein the second reference PRB is associated with the initial uplink BWP or with the second active uplink BWP.

Aspect 10: The method of aspect 9, wherein a quantity of bits associated with a FDRA portion of the uplink grant is based at least in part on the second set of usable uplink PRBs or the active uplink BWP.

Aspect 11: The method of any of aspects 9 through 10, wherein a quantity of PRBs associated with the second uplink grant is less than a first threshold and wherein the method further comprises: determining a quantity of bits associated with a FDRA portion of the second uplink grant such that the quantity of bits is equal to a threshold quantity of bits associated with the FDRA portion of the second uplink grant.

Aspect 12: A method for wireless communications at a network entity, comprising: transmitting information indicative of an initial uplink BWP, an active uplink BWP, or both; receiving, as part of an access procedure, a random access preamble message; transmitting, in response to reception of the random access preamble message, a random access response message comprising an uplink grant; and receiving, responsive to the uplink grant and based at least in part on a first PRB, an uplink scheduled random access message, wherein reception of the uplink scheduled random access message is within a set of usable uplink PRBs, the set of usable uplink PRBs based at least in part on the active uplink BWP and an uplink sub-band associated with a SBFD configuration, and wherein reception of the uplink scheduled random access message within the set of usable uplink PRBs is based at least in part on the first PRB being within the set of usable uplink PRBs or being offset from a reference PRB, wherein the reference PRB is associated with the initial uplink BWP or with the active uplink BWP.

Aspect 13: The method of aspect 12, further comprising: transmitting control signaling that indicates one or more offsets, wherein the first PRB is offset from the reference PRB based at least in part on an offset of the one or more offsets.

Aspect 14: The method of any of aspects 12 through 13, wherein the first PRB is associated with a lowest frequency of the set of usable uplink PRBs.

Aspect 15: The method of any of aspects 12 through 14, wherein the reference PRB is associated with a lowest frequency within the initial uplink BWP or is associated with a lowest frequency within the active uplink BWP.

Aspect 16: The method of any of aspects 12 through 15, wherein a quantity of bits associated with a FDRA portion of the uplink grant is based at least in part on the set of usable uplink PRBs or the active uplink BWP.

Aspect 17: The method of any of aspects 12 through 16, wherein a quantity of PRBs associated with the uplink grant is less than a first threshold and wherein the method further comprises: determining aa quantity of bits associated with a FDRA portion of the uplink grant such that the quantity of bits is equal to a threshold quantity of bits associated with the FDRA portion of the uplink grant.

Aspect 18: The method of any of aspects 12 through 17, wherein receiving the uplink scheduled random access message comprises: receiving the uplink scheduled random access message using a plurality of PRBs that are within the set of usable uplink PRBs, the plurality of PRBs positioned within the set of usable uplink PRBs in accordance with one or more scaling factors, one or more offsets, or any combination thereof.

Aspect 19: The method of aspect 18, wherein the uplink grant is indicative of a RIV, the RIV associated with a starting PRB and the plurality of PRBs, reception of the uplink scheduled random access message using the plurality of PRBs is based at least in part on the first PRB and the starting PRB.

Aspect 20: The method of any of aspects 12 through 19, further comprising: transmitting DCI based at least in part on transmitting the uplink scheduled random access message, wherein the DCI includes a second uplink grant for retransmission of the uplink scheduled random access message; and receiving, responsive to the second uplink grant and based at least in part on a second PRB, the uplink scheduled random access message as a retransmitted uplink scheduled random access message, wherein reception of the retransmitted uplink scheduled random access message is within a second set of usable uplink PRBs, the second set of usable uplink PRBs based at least in part on a second active uplink BWP and the uplink sub-band associated with the SBFD configuration, and wherein reception of the retransmitted uplink scheduled random access message within the second set of usable uplink PRBs is based at least in part on the second PRB being within the second set of usable uplink PRBs or being offset from a second reference PRB, wherein the second reference PRB is associated with the initial uplink BWP or with the second active uplink BWP.

Aspect 21: The method of aspect 20, wherein a quantity of bits associated with a FDRA portion of the uplink grant is based at least in part on the second set of usable uplink PRBs or the active uplink BWP.

Aspect 22: The method of any of aspects 20 through 21, wherein a quantity of PRBs associated with the second uplink grant is less than a first threshold and wherein the method further comprises: determining a quantity of bits associated with a FDRA portion of the second uplink grant such that the quantity of bits is equal to a threshold quantity of bits associated with the FDRA portion of the second uplink grant.

Aspect 23: A UE for wireless communications, comprising one or more memories storing processor-executable code, and one or more processors coupled with the one or more memories and individually or collectively operable to execute the code to cause the UE to perform a method of any of aspects 1 through 11.

Aspect 24: A UE for wireless communications, comprising at least one means for performing a method of any of aspects 1 through 11.

Aspect 25: A non-transitory computer-readable medium storing code for wireless communications, the code comprising instructions executable by one or more processors to perform a method of any of aspects 1 through 11.

Aspect 26: A network entity for wireless communications, comprising one or more memories storing processor-executable code, and one or more processors coupled with the one or more memories and individually or collectively operable to execute the code to cause the network entity to perform a method of any of aspects 12 through 22.

Aspect 27: A network entity for wireless communications, comprising at least one means for performing a method of any of aspects 12 through 22.

Aspect 28: A non-transitory computer-readable medium storing code for wireless communications, the code comprising instructions executable by one or more processors to perform a method of any of aspects 12 through 22.

Examples of these aspects may be combined with aspects or embodiments disclosed in other implementations.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive information indicative of an initial uplink bandwidth part, an active uplink bandwidth part, or both;
transmit, as part of an access procedure, a random access preamble message;
receive, in response to transmission of the random access preamble message, a random access response message comprising an uplink grant; and
transmit, responsive to the uplink grant and based at least in part on a first physical resource block (PRB), an uplink scheduled random access message, wherein:
transmission of the uplink scheduled random access message is within a set of usable uplink PRBs, the set of usable uplink PRBs based at least in part on the active uplink bandwidth part and an uplink sub-band associated with a sub-band full duplex configuration at the UE, and
transmission of the uplink scheduled random access message within the set of usable uplink PRBs is based at least in part on the first PRB being within the set of usable uplink PRBs or being offset from a reference PRB, wherein the reference PRB is associated with the initial uplink bandwidth part or with the active uplink bandwidth part.

2. The UE of claim 1, wherein the one or more processors are individually or collectively further operable to execute the code to cause the UE to:
receive control signaling that indicates one or more offsets, wherein the first PRB is offset from the reference PRB based at least in part on an offset of the one or more offsets.

3. The UE of claim 1, wherein the first PRB is associated with a lowest frequency of the set of usable uplink PRBs.

4. The UE of claim 1, wherein the reference PRB is associated with a lowest frequency within the initial uplink bandwidth part or is associated with a lowest frequency within the active uplink bandwidth part.

5. The UE of claim 1, wherein a quantity of bits associated with a frequency domain resource allocation portion of the uplink grant is based at least in part on the set of usable uplink PRBs or the active uplink bandwidth part.

6. The UE of claim 1, wherein a quantity of PRBs associated with the uplink grant is less than a first threshold, and the one or more processors are individually or collectively further operable to execute the code to cause the UE to:
determine a quantity of bits associated with a frequency domain resource allocation portion of the uplink grant such that the quantity of bits is equal to a threshold quantity of bits associated with the frequency domain resource allocation portion of the uplink grant.

7. The UE of claim 1, wherein, to transmit the uplink scheduled random access message, the one or more processors are individually or collectively operable to execute the code to cause the UE to:
transmit the uplink scheduled random access message using a plurality of PRBs that are within the set of usable uplink PRBs, the plurality of PRBs positioned within the set of usable uplink PRBs in accordance with one or more scaling factors, one or more offsets, or any combination thereof.

8. The UE of claim 7, wherein the uplink grant is indicative of a resource indication value, and the one or more processors are individually or collectively further operable to execute the code to cause the UE to:
determine a starting PRB and the plurality of PRBs based at least in part on the resource indication value, wherein transmission of the uplink scheduled random access message using the plurality of PRBs is based at least in part on the first PRB and the starting PRB.

9. The UE of claim 1, wherein the one or more processors are individually or collectively further operable to execute the code to cause the UE to:
receive downlink control information based at least in part on transmitting the uplink scheduled random access message, wherein the downlink control information includes a second uplink grant for retransmission of the uplink scheduled random access message; and
retransmitting, responsive to the second uplink grant and based at least in part on a second PRB, the uplink scheduled random access message as a retransmitted uplink scheduled random access message, wherein:
transmission of the retransmitted uplink scheduled random access message is within a second set of usable uplink PRBs, the second set of usable uplink PRBs based at least in part on a second active uplink bandwidth part and the uplink sub-band associated with the sub-band full duplex configuration at the UE, and
transmission of the retransmitted uplink scheduled random access message within the second set of usable uplink PRBs is based at least in part on the second PRB being within the second set of usable uplink PRBs or being offset from a second reference PRB, wherein the second reference PRB is associated with the initial uplink bandwidth part or with the second active uplink bandwidth part.

10. The UE of claim 9, wherein a quantity of bits associated with a frequency domain resource allocation portion of the uplink grant is based at least in part on the second set of usable uplink PRBs or the active uplink bandwidth part.

11. The UE of claim 9, wherein a quantity of PRBs associated with the second uplink grant is less than a first threshold, and the one or more processors are individually or collectively further operable to execute the code to cause the UE to:
determine a quantity of bits associated with a frequency domain resource allocation portion of the second uplink grant such that the quantity of bits is equal to a threshold quantity of bits associated with the frequency domain resource allocation portion of the second uplink grant.

12. A method for wireless communications at a user equipment (UE), comprising:
receiving information indicative of an initial uplink bandwidth part, an active uplink bandwidth part, or both;
transmitting, as part of an access procedure, a random access preamble message;
receiving, in response to transmission of the random access preamble message, a random access response message comprising an uplink grant; and
transmitting, responsive to the uplink grant and based at least in part on a first physical resource block (PRB), an uplink scheduled random access message, wherein:
transmission of the uplink scheduled random access message is within a set of usable uplink PRBs, the set of usable uplink PRBs based at least in part on the active uplink bandwidth part and an uplink sub-band associated with a sub-band full duplex configuration at the UE, and
transmission of the uplink scheduled random access message within the set of usable uplink PRBs is based at least in part on the first PRB being within the set of usable uplink PRBs or being offset from a reference PRB, wherein the reference PRB is associated with the initial uplink bandwidth part or with the active uplink bandwidth part.

13. The method of claim 12, further comprising:
receiving control signaling that indicates one or more offsets, wherein the first PRB is offset from the reference PRB based at least in part on an offset of the one or more offsets.

14. The method of claim 12, wherein a quantity of bits associated with a frequency domain resource allocation portion of the uplink grant is based at least in part on the set of usable uplink PRBs or the active uplink bandwidth part.

15. The method of claim 12, wherein a quantity of PRBs associated with the uplink grant is less than a first threshold, the method further comprising:
determining a quantity of bits associated with a frequency domain resource allocation portion of the uplink grant such that the quantity of bits is equal to a threshold quantity of bits associated with the frequency domain resource allocation portion of the uplink grant.

16. The method of claim 12, wherein transmitting the uplink scheduled random access message comprises:
transmitting the uplink scheduled random access message using a plurality of PRBs that are within the set of usable uplink PRBs, the plurality of PRBs positioned within the set of usable uplink PRBs in accordance with one or more scaling factors, one or more offsets, or any combination thereof.

17. A non-transitory computer-readable medium storing code, the code comprising instructions executable by one or more processors to:
receive information indicative of an initial uplink bandwidth part, an active uplink bandwidth part, or both;
transmit, as part of an access procedure, a random access preamble message;
receive, in response to transmission of the random access preamble message, a random access response message comprising an uplink grant; and
transmit, responsive to the uplink grant and based at least in part on a first physical resource block (PRB), an uplink scheduled random access message, wherein:
transmission of the uplink scheduled random access message is within a set of usable uplink PRBs, the set of usable uplink PRBs based at least in part on the active uplink bandwidth part and an uplink sub-band associated with a sub-band full duplex configuration at a user equipment (UE), and
transmission of the uplink scheduled random access message within the set of usable uplink PRBs is based at least in part on the first PRB being within the set of usable uplink PRBs or being offset from a reference PRB, wherein the reference PRB is associated with the initial uplink bandwidth part or with the active uplink bandwidth part.

18. The non-transitory computer-readable medium of claim 17, wherein the instructions are further executable by the one or more processors to:
receive control signaling that indicates one or more offsets, wherein the first PRB is offset from the reference PRB based at least in part on an offset of the one or more offsets.

19. The non-transitory computer-readable medium of claim 17, wherein a quantity of bits associated with a frequency domain resource allocation portion of the uplink grant is based at least in part on the set of usable uplink PRBs or the active uplink bandwidth part.

20. The non-transitory computer-readable medium of claim 17, wherein the instructions to transmit the uplink scheduled random access message are executable by the one or more processors to:
transmit the uplink scheduled random access message using a plurality of PRBs that are within the set of usable uplink PRBs, the plurality of PRBs positioned within the set of usable uplink PRBs in accordance with one or more scaling factors, one or more offsets, or any combination thereof.
